(19) United States
(12) Patent Application Publication
(10) Pub. No.: US 2025/0173996 A1
(43) Pub. Date: May 29, 2025

(54) OBJECT BOUNDARY DETECTION FOR AUTONOMOUS SYSTEMS AND APPLICATIONS

(71) Applicant: NVIDIA Corporation, Santa Clara, CA (US)

(72) Inventors: Wongun Choi, Los Altos, CA (US); ZhengJia Huang, San Jose, CA (US)

(21) Appl. No.: 18/520,098

(22) Filed: Nov. 27, 2023

(51) Int. Cl. G06V 10/44; G06V 10/82

(52) U.S. Cl. CPC G06V 10/44; G06V 10/82

(57) ABSTRACT

In various examples, object boundary detection for autonomous and semi-autonomous systems and applications is described. Systems and methods are disclosed that may use one or more machine learning models to process sensor data generated using a machine to generate one or more outputs indicating boundaries of objects surrounding the machine. In some examples, the output(s) may include confidence values (e.g., scores) associated with locations of an environment at least partially surrounding the machine, where the confidence values indicate whether an object boundary is located at the locations. In some examples, the output(s) (and/or an output from post-processing of the confidence values) may include an obstacle map indicating at least the boundaries of the objects. Additionally, in order for the machine learning model(s) to generate such outputs, systems and methods are further disclosed that train the machine learning model(s) using various types of ground truth data.

### BACKGROUND

Vehicles, such as semi-autonomous vehicles and/or autonomous vehicles, need to detect the locations of objects within an environment in order to safely navigate. For example, a vehicle may need to know the locations of other vehicles and/or pedestrians in order to avoid collisions with the other vehicles and/or pedestrians when navigating around roads within the environment. Additionally, the vehicle may need to know the locations of curbs located with the environment in order to safely park proximate to a curb such that the vehicle is no longer blocking a road that is adjacent the curb. As such, many conventional techniques have been developed in order to determine the locations of objects surrounding vehicles, such as based on determining boundaries of the objects.

For instance, some conventional systems use sensor data generated using a vehicle in order to determine distances to objects that are located proximate the vehicle. The sensor data may include image data, RADAR data, ultrasonic data, LiDAR data, and/or any other type of sensor data that may be used to determine distances to objects. In some circumstances, the conventional systems may then accumulate information indicating the distances to the objects over a period of time. Additionally, the conventional systems may use the accumulated information to generate a map, such as a birds-eye-view (BEV), top-down, and/or obstacle map, indicating the boundaries of the objects. While these techniques may accurately determine the locations of the object boundaries in many circumstances, these techniques may also underestimate and/or overestimate the locations of some object boundaries.

As such, other conventional systems may use neural networks to process sensor data generated using a vehicle and, based at least on the processing, generate a height map associated with the surrounding environment. For instance, the height map may indicate heights of objects that are located around the vehicle within the environment. These conventional systems may then use the height maps to determine the locations of the object boundaries, such as by using one or more threshold heights. For example, locations within the environment that include heights that are less than a threshold height may be considered free-space that the vehicle may navigate while locations within the environment that include heights that are equal to or greater than the threshold height may indicate object boundaries. Similar to the other techniques, while these techniques may accurately determine the locations of the object boundaries in many circumstances, these techniques may also underestimate and/or overestimate the locations of some object boundaries.

### SUMMARY

Embodiments of the present disclosure relate to object boundary detection for autonomous and semi-autonomous systems and applications. Systems and methods are disclosed that may use one or more machine learning models to process sensor data generated using a machine and, based at least on the processing, generate one or more outputs indicating boundaries of objects surrounding the machine. In some examples, the output(s) may include confidence values (e.g., scores) associated with locations of an environment at least partially surrounding the machine—where the confidence values indicate whether an object boundary is located at the locations. In some examples, the output(s) (and/or an output from post-processing of the confidence values) may include an obstacle map indicating at least the boundaries of the objects. Additionally, in order for the machine learning model(s) to generate such outputs, systems and methods are further disclosed that train the machine learning model(s) using various types of ground truth data, such as ground truth data representing similar confidence values and/or indications of boundary locations of objects.

In contrast to conventional systems, the current systems, in some embodiments, use the machine learning model(s) that may trained to directly generate the output(s) indicating the locations of object boundaries located within the environment. As described herein, this may provide improvements over the conventional systems that, as described above, may underestimate and/or overestimate at least some of the locations of object boundaries within the environment thus making the conventional systems less accurate. As described in more detail herein, in some examples, the machine learning model(s) of the current systems may be more accurate since the machine learning model(s) uses multiple types of sensor data to determine the locations of the object boundaries and/or are trained to specifically determine the locations of the object boundaries without any post-processing techniques.

### BRIEF DESCRIPTION OF THE DRAWINGS

The present systems and methods for object boundary detection for autonomous and semi-autonomous systems and applications are described in detail below with reference to the attached drawing figures, wherein:

FIG. 1 illustrates an example data flow diagram for a process of determining object boundaries using one or more machine learning models, in accordance with some embodiments of the present disclosure;

FIG. 2 illustrates an example of a machine navigating within an environment that includes objects, in accordance with some embodiments of the present disclosure;

FIGS. 3A-3B illustrate examples of boundary information that may be output by one or more machine learning models, in accordance with some embodiments of the present disclosure;

FIG. 4 illustrates an example of a grid map indicating locations associated with boundaries of objects located within an environment, in accordance with some embodiments of the present disclosure;

FIG. 5 illustrates an example of a height map associated with an environment surrounding a machine, in accordance with some embodiments of the present disclosure;

FIG. 6 illustrates an example of an obstacle map associated with an environment, in accordance with some embodiments of the present disclosure;

FIG. 7 illustrates an example of one or more machine learning models processing sensor data in order to determine locations of object boundaries, in accordance with some embodiments of the present disclosure;

FIG. 8 illustrates a data flow diagram illustrating a process for training one or more machine learning models to determine locations associated with object boundaries, in accordance with some embodiments of the present disclosure;

FIGS. 9-11 illustrate flow diagrams showing methods for determining locations associated with object boundaries, in accordance with some embodiments of the present disclosure;

FIG. 12A is an illustration of an example autonomous vehicle, in accordance with some embodiments of the present disclosure;

FIG. 12B is an example of camera locations and fields of view for the example autonomous vehicle of FIG. 12A, in accordance with some embodiments of the present disclosure;

FIG. 12C is a block diagram of an example system architecture for the example autonomous vehicle of FIG. 12A, in accordance with some embodiments of the present disclosure;

FIG. 12D is a system diagram for communication between cloud-based server(s) and the example autonomous vehicle of FIG. 12A, in accordance with some embodiments of the present disclosure;

FIG. 13 is a block diagram of an example computing device suitable for use in implementing some embodiments of the present disclosure; and

FIG. 14 is a block diagram of an example data center suitable for use in implementing some embodiments of the present disclosure.

### DETAILED DESCRIPTION

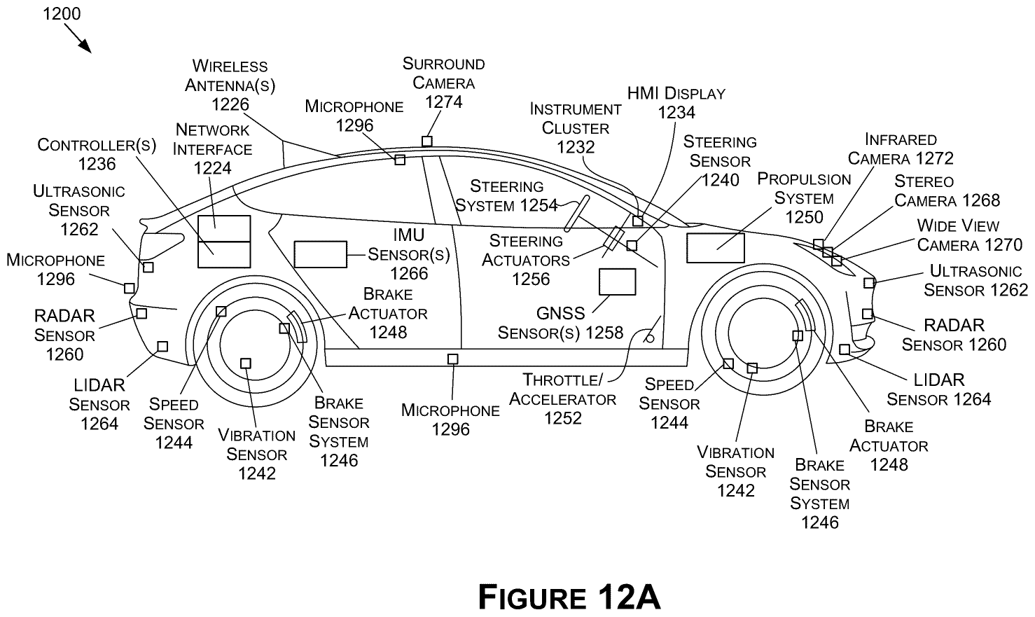

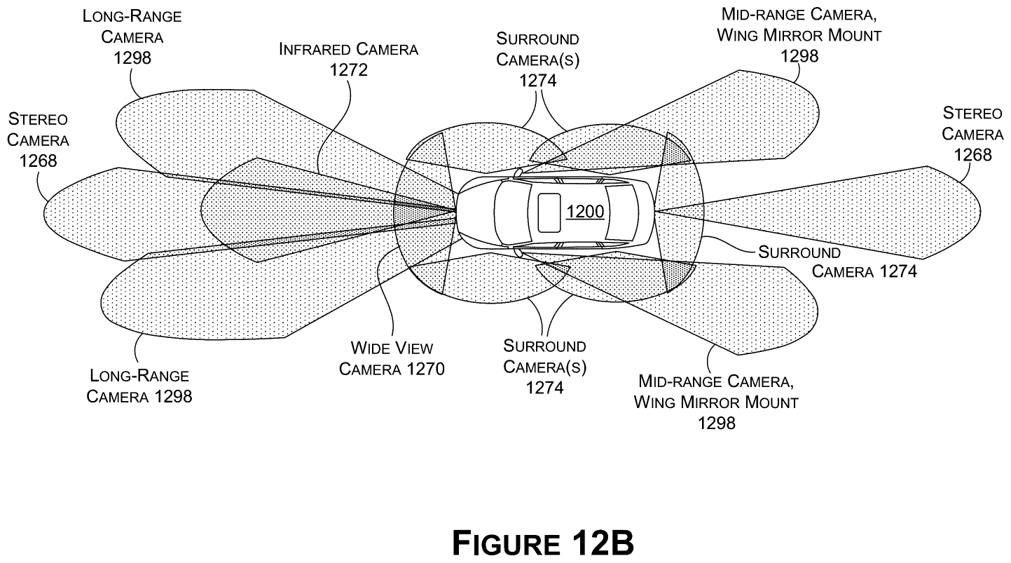

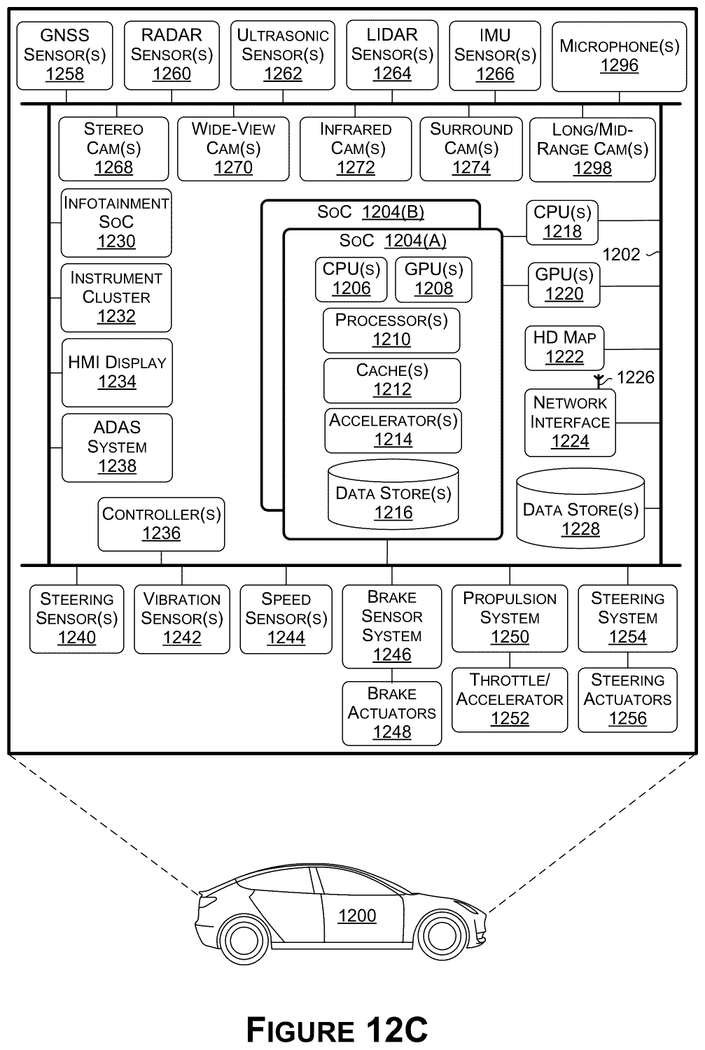

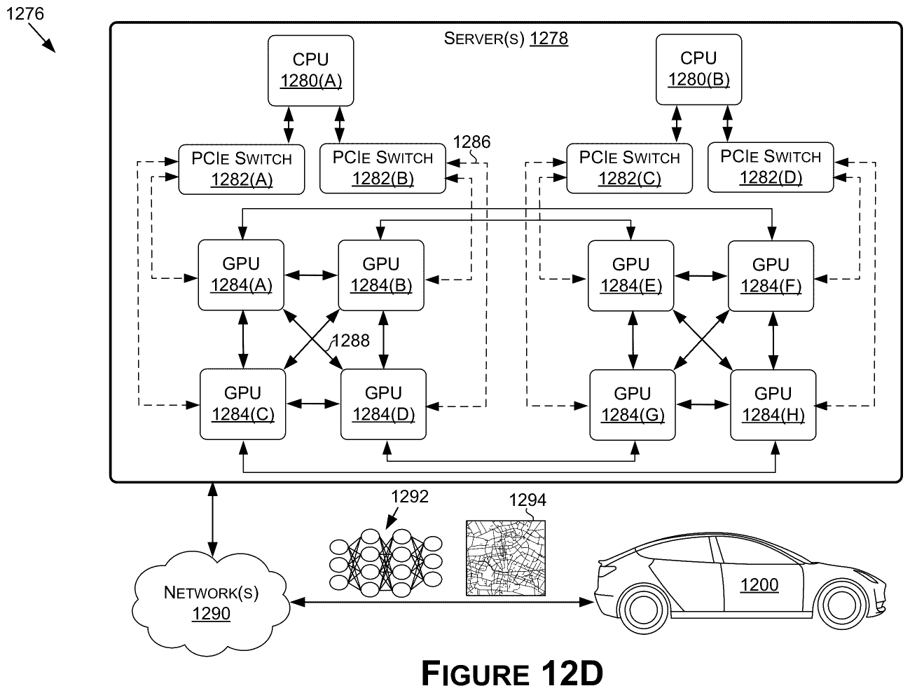

Systems and methods are disclosed related to object boundary detection for autonomous and semi-autonomous systems and applications. Although the present disclosure may be described with respect to an example autonomous or semi-autonomous vehicle 1200 (alternatively referred to herein as “vehicle 1200,” “ego-vehicle 1200,” “machine 1200,” or “ego-machine 1200,” an example of which is described with respect to FIGS. 12A-12D), this is not intended to be limiting. For example, the systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may be described with respect to obstacle boundary detection for autonomous or semi-autonomous applications, this is not intended to be limiting, and the systems and methods described herein may be used in augmented reality, virtual reality, mixed reality, robotics, security and surveillance, autonomous or semi-autonomous machine applications, and/or any other technology spaces where object detection may be used.

For instance, a system(s) may receive sensor data generated using a machine while navigating within an environment. As described herein, the sensor data may include, but is not limited to, image data generated using one or more image sensors of the machine, RADAR data generated using one or more RADAR sensors of the machine, ultrasonic data generated using one or more ultrasonic sensors of the machine, LiDAR data generated using one or more LiDAR sensors of the machine, and/or any other type of sensor data generated using any other type of sensor of the machine. In some examples, the system(s) may include an internal system(s) of the machine. Additionally, or alternatively, in some examples, the system(s) may be external to the machine and communicate with the machine using one or more networks.

The system(s) may then use one or more machine learning models to generate a map (referred to, in some examples, as an “obstacle map”) indicating at least one or more locations of one or more objects located within the environment and at least partially surrounding the machine. For instance, the system(s) may input at least a portion of the sensor data into the machine learning model(s). The machine learning model(s) (e.g., one or more first channels of the machine learning model(s)) may then be trained to generate a first output based at least on processing the at least the portion of the sensor data, where the first output is associated with the location(s) of one or more boundaries of the object(s) within the environment. For a first example, the first output may include one or more instances of confidence values extending in one or more directions from around the machine, where an instance of confidence values in a direction indicates a location of a boundary of an object in that direction. For instance, a maximum confidence value (e.g., 1) may indicate the location of a nearest object boundary to the machine while other confidence values (e.g., between 0-1) indicate locations for which the nearest object boundary is not located.

For a second example, the first output may include a map (referred to, in some examples, as a grid map, or evidence grid map (EGM)) of the environment surrounding the machine, where the grid map is partitioned into portions (e.g., cells, pixels, regions, tiles, etc.) corresponding to different locations surrounding the machine. Additionally, the portions may be associated with respective confidence values indicating whether object boundaries are located at the portions of the grid map. For instance, a maximum confidence value (e.g., 1) may indicate that a nearest object boundary is located at a portion of the grid map and other confidence values (e.g., between 0-1) may indicate that a nearest object boundary is not located at the portion of the grid map. While these examples include a maximum confidence value of 1 indicating an object boundary and other confidence values that are within a range between 0 and 1 as indicating no object boundary, in other examples, any other confidence values may indicate that an object boundary is located at a location within the environment and/or any other confidence values may indicate that an object boundary is not located at a location within the environment.

In some examples, the machine learning model(s) may further be trained to generate one or more additional outputs associated with the environment at least partially surrounding the machine. For a first example, the machine learning model(s) (e.g., one or more second channels of the machine learning model(s)) may be trained to generate a second output based at least on processing the at least the portion of the sensor data, where the second output includes at least a map (referred to, in some examples, as a “height map”) associated with the environment. For instance, and similar to the grid map, the height map may be partitioned into portions (e.g., cells, pixels, regions, tiles, etc.) corresponding to different locations surrounding the machine. Additionally, the portions of the height map may be associated with height values indicating the heights of objects surrounding the machine. For a second example, the machine learning model(s) (e.g., one or more third channels of the machine learning model(s)) may be trained to generate a third output based at least on processing the at least the portion of the sensor data, where the third output includes at least data (referred to, in some examples, as “uncertainty data”) representing one or more uncertainty values indicating whether one or more locations within the environment are visible to the machine or not visible to the machine.

The system(s) (e.g., the machine learning model(s)) may then be configured to generate the obstacle map indicating the location(s) of the object(s) at least partially surrounding the machine. As described herein, the obstacle map may indicate at least the location(s) of the object(s) within the environment, the boundary locations associated with the object(s) within the environment, the free-space locations within the environment, the visible areas of the environment, the non-visible areas of the environment, and/or any other information associated with the environment surrounding the machine. In some examples, the system(s) may generate the obstacle map using at least a portion of the first output, at least a portion of the second output, and/or at least a portion of the third output. For a first example, the system(s) (e.g., the machine learning model(s)) may use the first output (e.g., the confidence values) to determine the locations associated with boundaries of the object(s) within the environment, which is described in more detail herein. The system(s) (e.g., the machine learning model(s)) may then use the locations associated with the boundaries to generate the obstacle map.

For a second example, the system (e.g., the machine learning model(s)) may use at least a portion of the second output and/or at least a portion of the third output to determine proximate locations associated with the boundaries of the object(s) within the environment. The system(s) (e.g., the machine learning model(s)) may then use the first output and the proximate locations to determine the final locations associated with the boundaries of the object(s) within the environment, which is described in more detail herein. Additionally, the system(s) (e.g., the machine learning model(s)) may then use the final locations associated with the boundaries to generate the obstacle map. While these are just a few example techniques of how the system(s) may use the output(s) to generate the obstacle map, in other examples, the system(s) may use one or more additional and/or alternative techniques to generate the obstacle map. Additionally, and as described herein, by using the machine learning model(s) that is trained to output the first data associated with the exact boundary locations, the obstacle map generated using the system(s) may include more accurate boundary locations as compared to conventional systems that generate obstacle maps.

In some examples, the system(s) (and/or one or more other systems) may use one or more techniques to train the machine learning model(s). For example, the system(s) may train the machine learning model(s) using input data, which may include similar sensor data as the sensor data processed by the machine learning model(s) when generating the output(s) described herein. The system(s) may further train the machine learning model(s) using ground truth data, where the ground truth data may be similar to the output(s) generated by the machine learning model(s). For example, the system(s) may train the first channel(s) of the machine learning model(s) using first training data (e.g., instances of confidence values, grid maps, etc.) that is similar to the first output, the second channel(s) of the machine learning model(s) using second ground truth data (e.g., height maps, etc.) that is similar to the second output, and/or the third channel(s) of the machine learning model(s) using third ground truth data (e.g., uncertainty values, boundaries between visible and non-visible areas, etc.) that is similar to the third output. For instance, and as described more herein, the training may include determining a first loss associated with the first channel(s), the second loss associated with the second channel(s), and/or a third loss associated with the third channel(s). Additionally, in some examples, the training may include determining a final loss based at least on the first loss, the second loss, and/or the third loss. The training may then include updating one or more weights and/or biases associated with one or more parameters of the machine learning model(s) using the first loss, the second loss, the third loss, and/or the final loss.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, autonomous or semi-autonomous machine applications, deep learning, environment simulation, object or actor simulation and/or digital twinning, data center processing, conversational AI, light transport simulation (e.g., ray tracing, path tracing, etc.), collaborative content creation for 3D assets, cloud computing, generative AI, (large) language models, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems that implement one or more large language models (LLMs), systems for performing light transport simulation, systems for performing collaborative content creation for 3D assets, systems implemented at least partially using cloud computing resources, systems for performing generative AI operations, systems implementing—or for performing operations using-a large language model (LLM), and/or other types of systems.

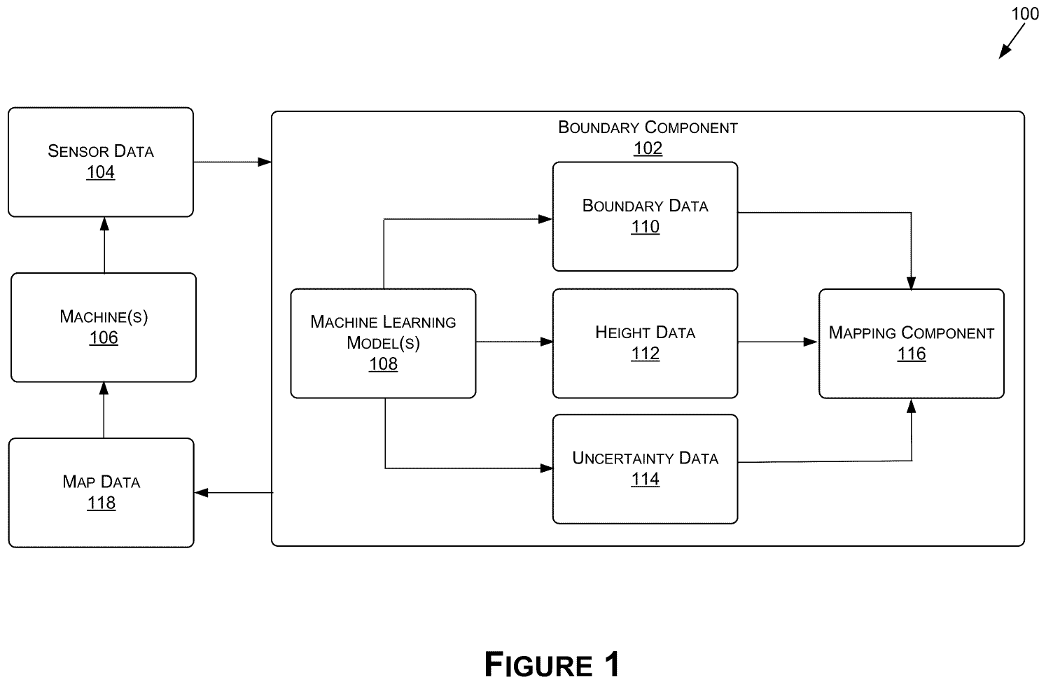

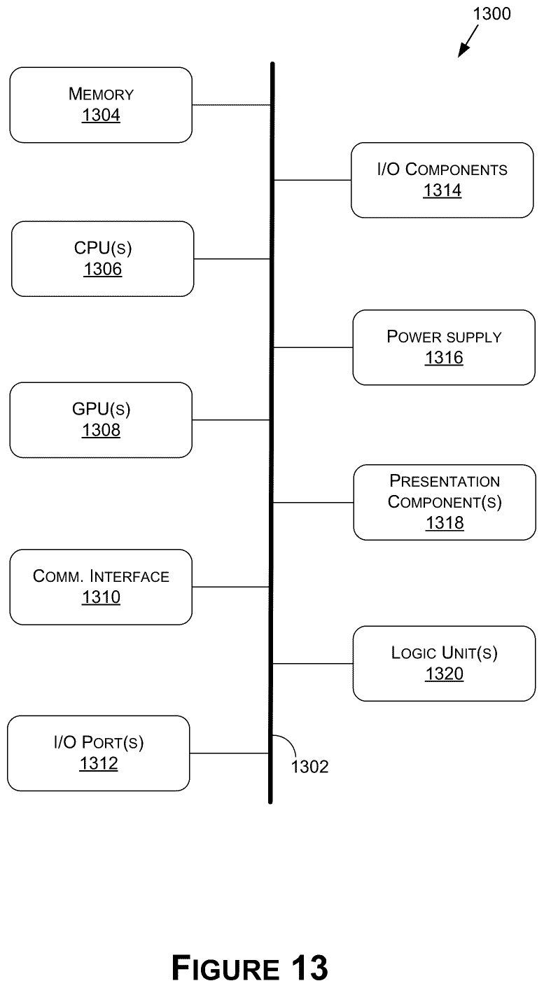

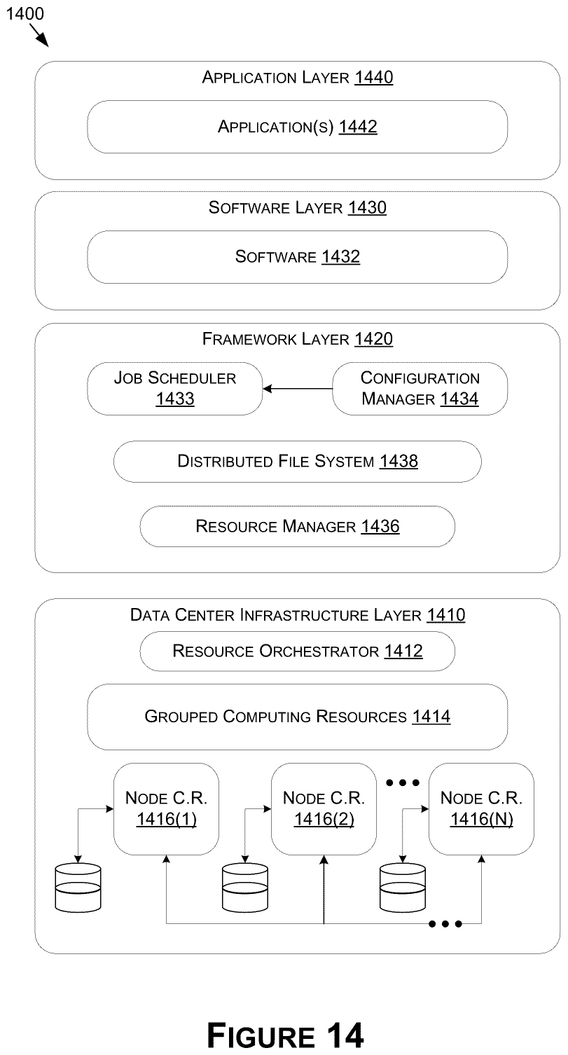

With reference to FIG. 1, FIG. 1 illustrates an example data flow diagram for a process 100 of determining object boundaries using one or more machine learning models, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 1200 of FIGS. 12A-12D, example computing device 1300 of FIG. 13, and/or example data center 1400 of FIG. 14.

The process 100 may include a boundary component 102 receiving sensor data 104 generated using at least one machine 106 (which may represent, and/or include, an autonomous vehicle 1200). As described herein, the sensor data 104 may include, but is not limited to, image data generated using one or more image sensors of the machine 106, RADAR data generated using one or more RADAR sensors of the machine 106, ultrasonic data generated using one or more ultrasonic sensors of the machine 106, LiDAR data generated using one or more LiDAR sensors of the machine 106, and/or any other type of sensor data generated using any other type of sensor (e.g., any other type of sensor modality) of the machine 106. In some examples, the boundary component 102 may be continuously receiving the sensor data 104 from the machine 106. In some examples, the boundary component 102 may receive the sensor data 104 that the elapse of give time intervals (e.g., every millisecond, second, two seconds, five seconds, etc.). Additionally, while the example of FIG. 1 illustrates the boundary component 102 as being separate from the machine 106 (e.g., for illustration purposes), in other examples, the boundary component 102 may be included as part of the machine 106. For instance, the boundary component 102 may be executed by one or more systems of the machine 106.

As described herein, the sensor data 104 may represent an environment for which the machine 106 is located and/or navigating. For instance, the sensor data 104 may represent at least objects that are at least partially surrounding the machine 106 within the environment. As described herein, an object may include, but is not limited to, a vehicle, a pedestrian, a road, a traffic sign, a traffic light, a curb, an animal, a structure, a parking space, and/or any other type of object that may be located within the environment.

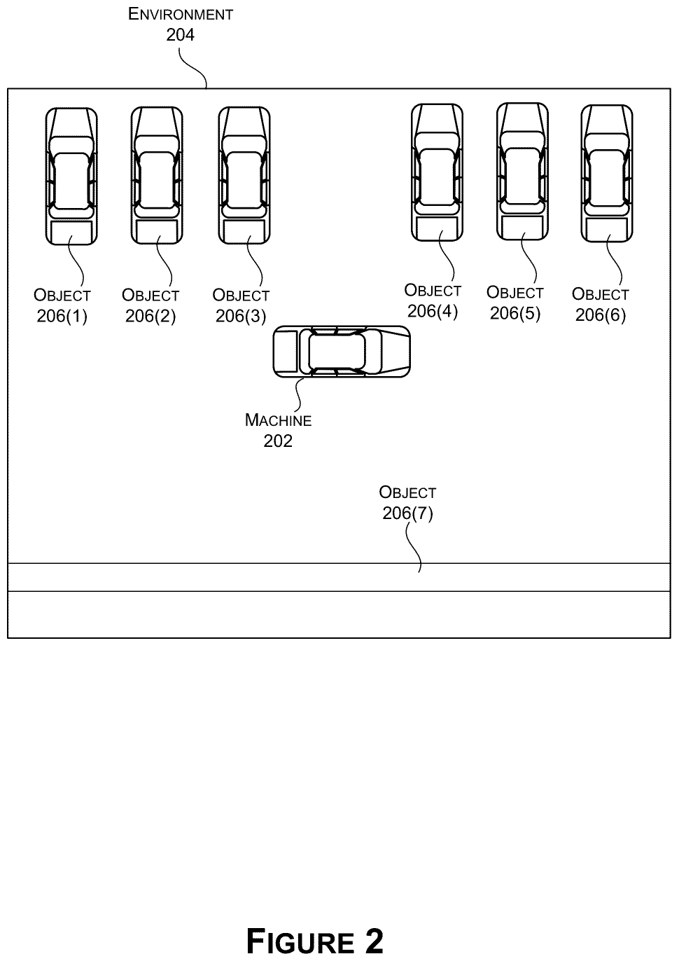

For instance, FIG. 2 illustrates an example of a machine 202 (e.g., a vehicle) (which may represent, and/or include, one of the machine(s) 106) navigating within an environment 204 that includes objects 206(1)-(7) (also referred to singularly as “object 206” or in plural as “objects 206”), in accordance with some embodiments of the present disclosure. In the example of FIG. 2, the objects 206(1)-(6) may include other vehicles that are parked within the environment 204 and the object 206(7) may include a curb, where the machine 202 is able to park proximate to the curb within the environment 204. While navigating within the environment 204, the machine 202 may generate sensor data (e.g., the sensor data 104) representing the objects 206 within the environment 204. The machine 202 may then process the sensor data using the boundary component 102, such as when the boundary component 102 is internal to the machine 202, or send the sensor data to the boundary component 102 (e.g., a system executing the boundary component 102), such as when the boundary component 102 is external to the machine 202.

Referring back to the example of FIG. 1, the process 100 may include the boundary component 102 inputting at least a portion of the sensor data 104 (pre-processed, raw, post-processed, etc.) into one or more machine learning models 108 that are trained to determine information associated with objects located within the environment, such as boundary information. For instance, and as shown, the boundary component 102 may input at least a portion of the sensor data 104 into the machine learning model(s) 108, such as the image data, the LiDAR data, the ultrasonic data, the RADAR data, and/or any other type of data. The machine learning model(s) 108 may process the sensor data 104 and, based at least on the processing, the machine learning model(s) 108 (e.g., one or more first channels, which may be represented by the top arrow) may generate boundary data 110 associated with the objects. As described herein, the boundary data 110 may represent various types of boundary information associated with the objects.

For instance, in some examples, the boundary data 110 may represent an instance of data representing confidence values that are projected from the machine 106 in various directions. For instance, and for an instance of data, the confidence values may be associated with various distances from the machine 106, where the confidence values include values that are within a range. As described herein, the range may include, but is not limited to, 0-1, 0-10, 0-100, and/or any other range. In such examples, the instance of data may then be used to determine a distance to a nearest object boundary from the machine 106 and in the direction associated with the instance of data. For instance, the distance may be determined based at least on the maximum confidence value in the direction relative to the machine 106. For example, if the confidence values are within a range between 0 and 1, then a given distance from the machine 106 and along the direction may be associated with the confidence value 1 while the rest of the distances are associated with confidence values that are less than 1. Similar processes may then be used to determine other distances to other object boundaries that are around the machine 106.

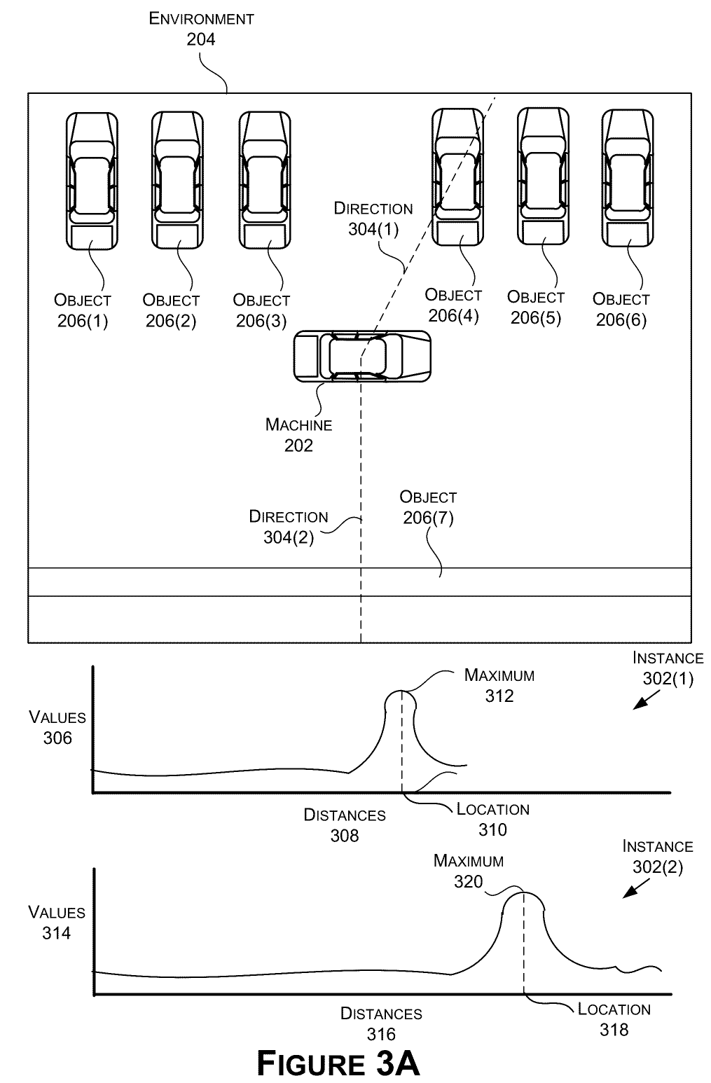

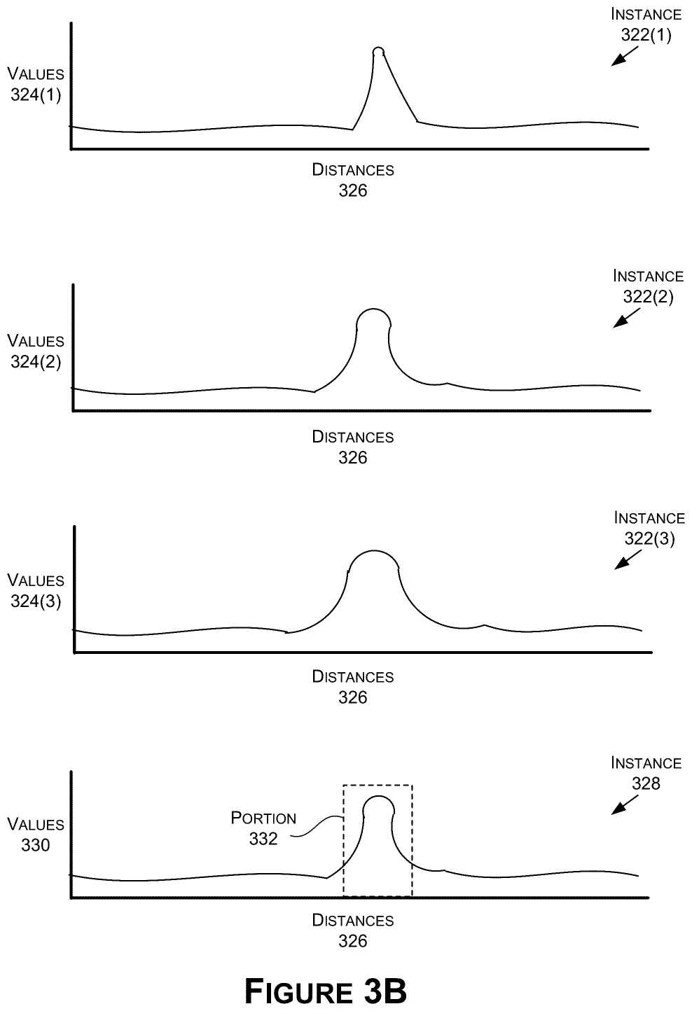

For instance, FIG. 3A illustrates a first example of boundary information that may be output by the machine learning model(s) 108, in accordance with some embodiments with the present disclosure. As shown, a first instance of data 302(1) may be associated with a first direction 304(1) with respect to the machine 202, where the first instance of data 302(1) represents confidence values 306 along distances 308 extending from the machine 202. As such, using the first instance of data 302(1), the boundary component 102 (e.g., the machine learning model(s) 108) may determine a distance and/or location 310 associated with a closest object boundary to the machine 202 and in the first direction 304(1). For instance, the boundary component 102 may determine the distance and/or location 310 as corresponding to a maximum confidence value 312 from the confidence values 306. In the example of FIG. 3A, the distance and/or location 310 may correspond to the boundary of the object 206(4) along the first direction 304(1).

Additionally, a second instance of data 302(2) may be associated with a second direction 304(2) with respect to the machine 202, where the second instance of data 302(2) represents confidence values 314 along distances 316 extending from the machine 202. As such, using the second instance of data 302(2), the boundary component 102 (e.g., the machine learning model(s) 108) may determine a distance and/or location 318 associated with a closest object boundary to the machine 202 and in the second direction 304(2). For instance, the boundary component 102 may determine the distance and/or location 318 as corresponding to a maximum confidence value 320 from the confidence values 314. In the example of FIG. 3B, the distance and/or location 318 may correspond to the boundary of the object 206(7) along the second direction 304(2).

While the example of FIG. 3A illustrates using two instances of data 302(1)-(2) to determine two distances and/or locations associated with boundaries of the objects 206 within the environment 204, in other examples, similar processes may be performed with regard to any number of instances of data associated with any number of directions. Additionally, while the example of FIG. 3A illustrates using the maximum confidence values 312 and 320 to determine the distances and/or locations of the nearest objects 206 within the environment 204, in other examples, the boundary component 102 may use the minimum confidence values, the average confidence values, threshold confidence values, and/or any other technique to determine the distances and/or locations of the nearest objects 206. Furthermore, and with reference to FIG. 1, in some examples, the boundary data 110 may represent the instances of data 302(1)-(2) while, in some examples, the boundary data 110 may represent the distances and/or locations associated with the boundaries after the additional processing of the instances of data 302(1)-(2).

In some examples, in addition to, or alternatively from, the boundary data 110 representing the final instances of data (as illustrated in FIG. 3A), the machine learning model(s) 108 may generate boundary data 110 representing different instances of data associated with different sensor modalities. For instance, and for a direction, the machine learning model(s) 108 may generate boundary data 110 representing a first instance of data associated with a first sensor modality (e.g., an image sensor using image data), a second instance of data associated with a second sensor modality (e.g., a LiDAR sensor using LiDAR data), a third instance of data associated with a third sensor modality (e.g., a RADAR sensor using RADAR data), and/or so forth. In such an example, the machine learning model(s) 108 (and/or another component) may then determine a final instance of data using one or more of the instances of data.

For instance, FIG. 3B illustrates a second example of boundary information that may be output by the machine learning model(s) 108, in accordance with some embodiments with the present disclosure. As shown, the machine learning model(s) 108 may generate boundary data 110 representing at least a first instance of data 322(1) that includes first confidence values 324(1) over distances 326 from the machine 202, a second instance of data 322(2) that includes second confidence values 324(2) over the distances 326 from the machine 202, and a third instance of data 322(3) that includes third confidence values 324(3) over the distances 326 from the machine 202. As described herein, the first instance of data 322(1) may be associated with a first sensor modality (e.g., generated using first sensor data), the second instance of data 322(2) may be associated with a second sensor modality (e.g., generated using second sensor data), and the third instance of data 322(3) may be associated with a third sensor modality (e.g., generated using third sensor data).

In some examples, the machine learning model(s) 108 (and/or another component) may then generate a final instance of data 328 using one or more of the instances of data 322(1)-(3), where the final instance of data 328 includes confidence values 330 over the distances 326 from the machine 202. In some examples, the machine learning model(s) 108 (and/or the other component) may generate the final instance of data 328 as an average of the instances of data 322(1)-(3). In some examples, the machine learning model(s) 108 (and/or the other component) may generate the final instance of data 328 as adding the instances of data 322(1)-(3). In some examples, the machine learning model(s) 108 (and/or the other component) may determine the final instance of data 328 by providing one or more weights to one or more of the instances of data 322(1)-(3). Still, in some examples, the machine learning model(s) 108 (and/or the other component) may generate the final instance of data 328 using any other technique and based at least on the instances of data 322(1)-(3).

Referring back to the example of FIG. 1, in addition to, or alternatively from, the boundary data 110 representing the instances of data, in some examples, the machine learning model(s) 108 may generate boundary data 110 representing a map (referred to, in some examples, as a “grid map” or “evidence grid map (EGM”) associated with the environment, where the grid map is portioned into various portions corresponding to various locations of the environment. As described herein, a portion may include, but is not limited to, a pixel, a cell, a tile, a region, and/or any other type of area of a map. In some examples, each of the portions may represent a similar sized area of the map, such as a 4 centimeter by 4 centimeter sized area (and/or any other sized area) of the grid map. However, in other examples, one or more portions of the grid map may represent different sized areas of the grid map as compared to one or more additional portions of the grid map. Additionally, in some examples, a location associated with the machine 106 may be located within a specific area of the grid map, such as the center of the grid map, a corner of the grid map, a side of the grid map, and/or any other area.

The boundary data 110 may further represent one or more confidence values for one or more portions of the grid map. For instance, in some examples, the boundary data 110 may represent a respective confidence value for each of the portions of the grid map. Similar to the instances of data, the confidence values may be associated with a range such as, but not limited to, 0-1, 0-10, 0-100, and/or any other range. For example, portions of the grid map that correspond to locations within the environment of the nearest object boundaries with respect to the machine 106 may be associated with a maximum confidence value (e.g., a confidence value if 1) while portions of the grid map that correspond to other locations within the environment may be associated with confidence values that are less than the maximum confidence value (e.g., confidence values between 0 and 1).

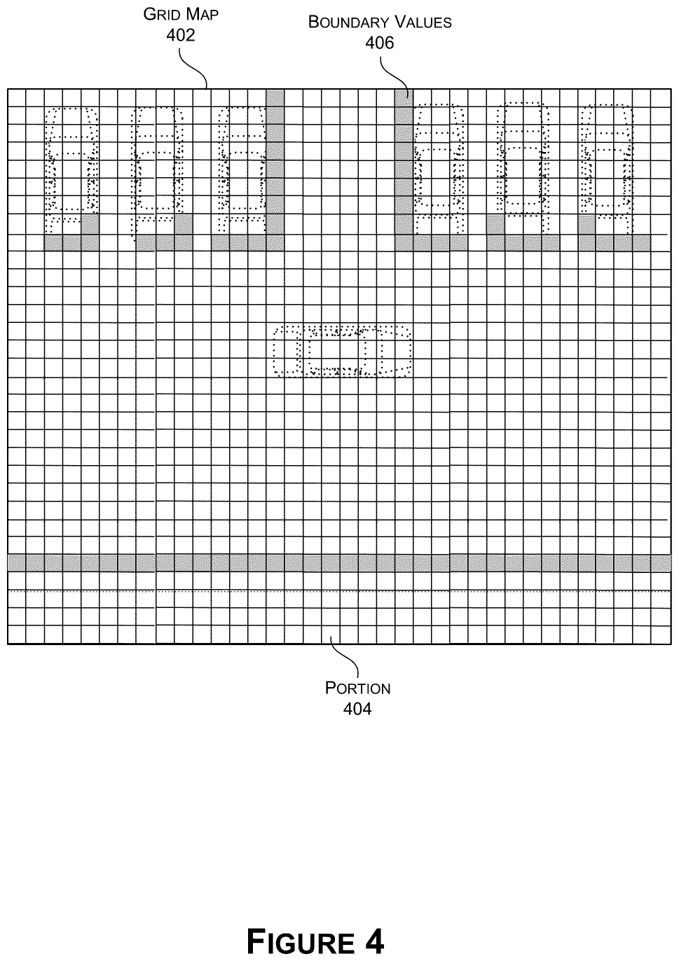

For instance, FIG. 4 illustrates an example of a grid map 402 indicating locations of boundaries associated with the objects 206 located within the environment 204, in accordance with some embodiments of the present disclosure. As shown, the grid map 402 may be partitioned into numerous portions 404 (although only one is labeled for clarity reasons), where the portions 404 correspond to different locations and/or areas within the environment 204. Additionally, one or more of the portions 404 (e.g., each portion 404) of the grid map 402 may be associated with confidence values (which may be represented by the boundary data 110) indicating whether a closest boundary of an object 206 to the machine 202 is located at the portion 404. In the example of FIG. 4, the portions 404 of the grid map 402 that are associated with maximum confidence values 402 are indicated by grey shading, where these portions 404 of the grid map 402 may be associated with the closest boundaries of the objects 206. Additionally, other portions 404 of the grid map 402 may be associated with confidence values that are less than the maximum confidence value.

Referring back to the example of FIG. 1, additionally to, or alternatively from, the boundary data 110 representing the instances of data and/or the grid map, in other examples, the machine learning model(s) 108 may generate boundary data 110 representing any other type of information (e.g., an obstacle map, etc.) that indicates the locations associated with the boundaries of the objects. In other words, and as described in more detail herein, the machine learning model(s) 108 may be trained to generate the boundary data 110 that directly indicates the locations associated with the boundaries of the objects within the environment.

In some examples, and as illustrated by the example of FIG. 1, the process 100 may include the machine learning model(s) 108 (e.g., one or more second channels, which may be represented by the middle arrow) generating height data 112 associated with the objects. As described herein, in some examples, the height data 112 may represent a height map associated with the environment that is at least partially surrounding the machine 106, where the height map indicates the heights of the surrounding objects. In some examples, the height map may be partitioned into various portions (e.g., similar to the grid map), where a portion includes a pixel, a cell, a tile, a region, and/or any other type of area of the height map. In such examples, one or more of the portions (e.g., each portion) of the height map may be associated with a respective height value.

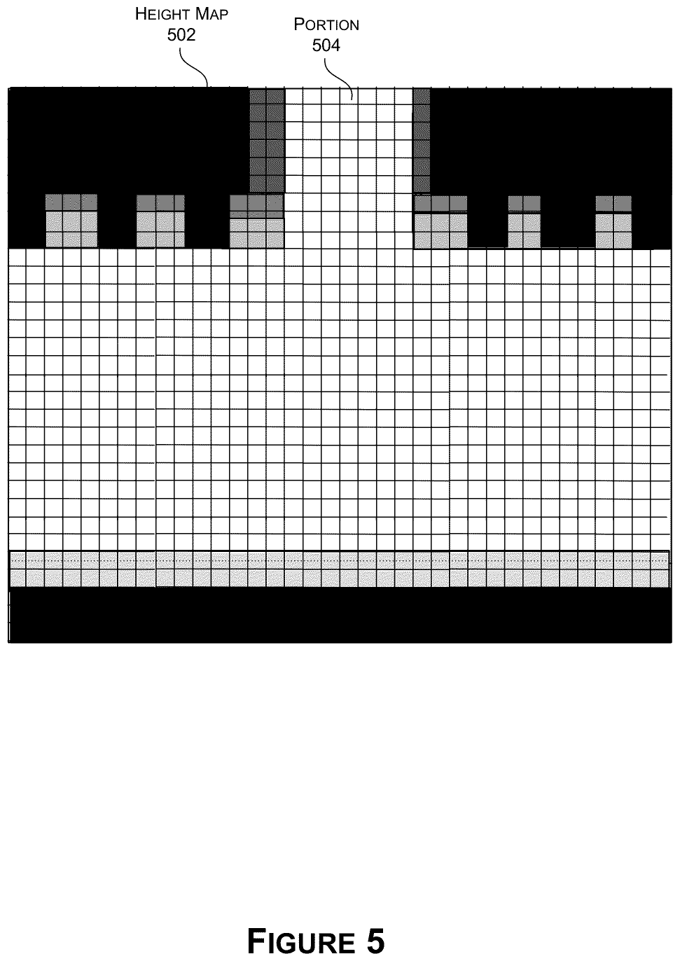

For instance, FIG. 5 illustrates an example of a height map 502 associated with the environment 204 surrounding the machine 202, in accordance with some embodiments of the present disclosure. As shown by the example of FIG. 5, the height map 502 may be portioned into various portions 504 (although only one is labeled for clarity reasons), where the portions 504 correspond to various locations and/or areas associated with the environment 204. Additionally, at least some of the portions 504 may be associated with height values associated with the environment 204, such as the objects 206 located within the environment 204 and/or the driving surface for which the machine 202 is navigating. In the example of FIG. 5, the height values may be represented by the shading, where darker shading indicates a higher height value. Additionally, in the example of FIG. 5, the darkest shading (e.g., the black shading) may be associated with locations and/or areas of the environment 204 for which the machine learning model(s) 108 was unable to determine height information, such as because the locations and/or areas being block by other objects 206.

Referring back to the example of FIG. 1, in some examples, the process 100 may include the machine learning model(s) 108 (e.g., one or more third channels, which may be represented by the bottom arrow) generating uncertainty data 114 representing one or more uncertainty values. In some examples, the uncertainty values may be associated with whether one or more locations and/or areas of the environment are visible with respect to the machine 106. For example, the uncertainty values may be lower when associated with locations and/or areas that are not visible to the machine 106 based on the sensor data 104 and greater when associated with locations and/or areas that are visible to the machine 106 based on the sensor data 104. However, in other examples, the uncertainty values may represent any other type of uncertainty.

For instance, and referring back to the example of FIG. 5, in some examples, the uncertainty data 114 may represent uncertainty values associated with the portions 504 of the height map 502. As described herein, the uncertainty values may indicate whether the portions 504 of the height map are visible to the machine 202 or whether the portions of the height map 502 are not visible to the machine 202.

Referring back to the example of FIG. 1, the process 100 may include a mapping component 116 processing at least a portion of the boundary data 110, at least a portion of the height data 112, and/or at least a portion of the uncertainty data 114 in order to generate map data 118 associated with the environment. While the example of FIG. 1 illustrates the mapping component 116 as being separate from the machine learning model(s) 108, in other examples, the mapping component 116 may be included as part of the machine learning model(s) 108. For example, the mapping component 116 may include one or more layers of the machine learning model(s) 108 that are trained to generate the map data 118 using at least a portion of the boundary data 110, at least a portion of the height data 112, and/or at least a portion of the uncertainty data 114. Additionally, as described herein, the map data 118 may represent an obstacle map associated with at least a portion of the environment surrounding the machine 106.

In some examples, the mapping component 116 may use one or more techniques to generate the map data 118. For a first example, the mapping component 116 may process the boundary data 110 representing the instances of data at least partially surrounding the machine 106 in different directions. Based at least on the processing, and using one or more of the techniques described herein (e.g., identifying the maximum confidence values, such as the maximum values 312 and 320 in the example of FIG. 3A), the mapping component 116 may determine the distances to and/or the locations of the object boundaries (e.g., the nearest object boundaries) within the environment. The mapping component 116 may then generate the obstacle map to indicate the locations of the object boundaries within the environment and at least partially surrounding the machine 106.

For a second example, the mapping component 116 may process the boundary data 110 representing the grid map associated with the environment. Based at least on the processing, the mapping component 116 may identify the locations and/or areas of the environment that are associated with the object boundaries. For example, the mapping component 116 may identify the portions of the grid map that are associated with the maximum confidence values (e.g., the portions 404 with the grey shading in the example of FIG. 4) and then determine the locations and/or the areas of the environment as corresponding to the portions of the grid map. The mapping component 116 may then generate the obstacle map to indicate the locations and/or areas of the object boundaries within the environment.

For a third example, the mapping component 116 may process the height data 112 and/or the uncertainty data 114 in order to identify potential locations (e.g., potential areas) within the environment for which the object boundaries may be located. In some examples, to determine the potential locations, the mapping component 116 may identify portions of the height map for which the height values satisfy (e.g., are equal to or greater than) a threshold height (e.g., 10 centimeters, 20 centimeters, 30 centimeters, etc.). The mapping component 116 may then determine that the identified portions of the height map correspond to the potential locations of the object boundaries within the environment. The mapping component 116 may then use the bounding data 110 to determine more exact locations within the environment for which the object boundaries are located.

For instance, in some examples, if the boundary data 110 represents the instances of data, then the mapping component 116 may just process portions of the instances of data that correspond to the potential locations to determine the exact locations. For example, and referring back to the example of FIG. 3B, the mapping component 116 may initially use the height map to determine the potential locations for a boundary of an object 206. The mapping component 116 may then determine that the potential locations correspond to a portion 332 of the final instance of data 328. As such, the mapping component 116 may only process the portion 332 of the confidence values 330 in order to identify the maximum confidence value 330. Additionally, the mapping component 116 may use the maximum confidence value 330 to determine the precise location for the boundary of the object 206. The mapping component 116 may then generate the obstacle map to indicate the final locations and/or areas of the object boundaries within the environment.

Additionally, or alternatively, in some examples, if the boundary data 110 represents the grid map, then the mapping component 116 may just processes portions of the grid map that are associated with the potential locations to determine the exact locations. For instance, and referring back to the example of FIG. 4, the mapping component 116 may initially use the height map to determine the potential locations for a boundary of an object 206. The mapping component 116 may then determine that the potential locations correspond to one or more portions 404 of the grid map 402. As such, the mapping component 116 may only process that portion(s) 404 of the grid map 402, without processing one or more additional portions of the grid map 402, to determine which of the portion(s) 404 is associated with the maximum confidence value. Additionally, the mapping component 116 may use the maximum confidence value to determine the precise location for the boundary of the object 206. The mapping component 116 may then generate the obstacle map to indicate the final locations and/or areas of the object boundaries within the environment.

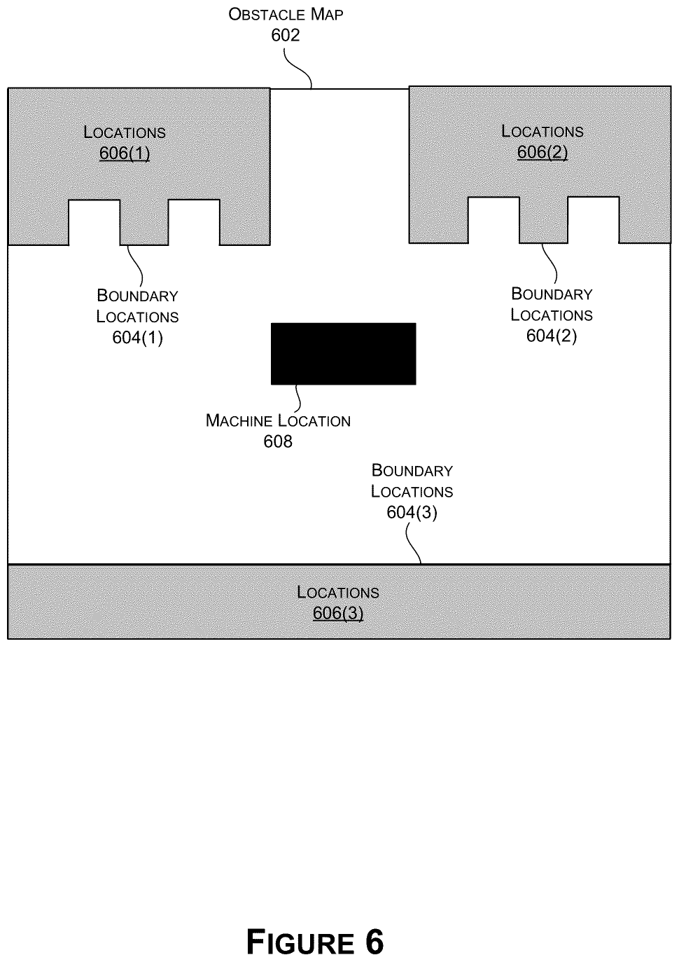

For instance, FIG. 6 illustrates an example of an obstacle map 602 associated with the environment 204, in accordance with some embodiments of the present disclosure. As shown, the obstacle map 602 may indicate at least boundary locations 604(1) associated with the objects 206(1)-(3), boundary locations 604(2) associated with the objects 206(4)-(6), and boundary locations 604(3) associated with the object 206(7), where the boundary locations 604(1)-(3) are represented by the black line between the white shading of the obstacle map 602 and the grey shading of the obstacle map 602. The obstacle map 602 may further indicate locations 606(1)-(3) within the environment 204 that are either occupied by the objects 206 and/or not visible to the machine 202 based at least on the locations 606(1)-(3) being occluded by portions the objects 206, which are represented by the grey shading. Additionally, the obstacle map 602 may indicate a location 608 within the environment 204 that is occupied by the machine 202, which is represented by the black shading. While the obstacle map 602 in the example of FIG. 6 has the location 608 of the machine 202 located within the middle of the obstacle map 602, in other examples, the location 608 of the machine 202 may be located at a different portion of the obstacle map 602.

Referring back to the example of FIG. 1, the process 100 may include the boundary component 102 sending the map data 118 to the machine 106. This way, the machine 106 is able to use the obstacle map in order to navigate within the environment. For instance, the machine 106 may use the obstacle map when determining a trajectory to navigate in order to avoid colliding with the objects located within the environment. In some examples, the process 100 may then continue to repeat, either continuously and/or at specific time intervals, such that the boundary component 102 is able to continually provide the machine 106 with map data 118 represented updated obstacle maps.

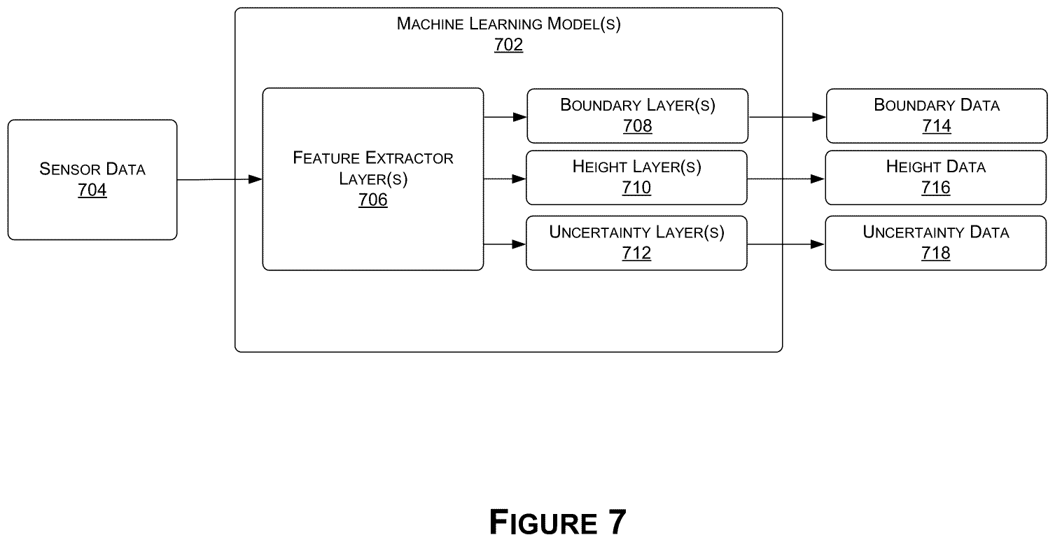

FIG. 7 illustrates an example of one or more machine learning models 702 (which may represent, and/or include, the machine learning model(s) 108) that are configured to determine locations of object boundaries, in accordance with some embodiments of the present disclosure. The machine learning model(s) 702 may be one example of a machine learning model that may be used to perform one or more of the processes described herein. In some examples, the machine learning model(s) 702 may include or be referred to as a convolutional neural network and thus may alternatively be referred to herein as convolutional neural network 702, convolutional network 702, or CNN 702. However, in other examples, the machine learning model(s) 702 may include any other type of neural network.

As described herein, the machine learning model(s) 702 may use sensor data 804 (which may represent, and/or include, the sensor data 104) as an input. The sensor data 804 may include, but is not limited to, image data generated using one or more image sensors, LiDAR data generated using one or more LiDAR sensors, ultrasonic data generated using one or more ultrasonic sensors, RADAR data generated using one or more RADAR sensors, and/or any other type of sensor data generated using any other type of sensor. The sensor data 704 may be input as one or more single frames generated using each type of sensor modality, or may be input using batching, such as mini-batching. For example, multiple frames may be used as inputs together (e.g., at the same time).

The sensor data 704 may be input into one or more feature extractor layers 706 of the machine learning model(s) 702. The feature extractor layer(s) 704 may include any number of layers 706. One or more of the layers 706 may include an input layer. The input layer may hold values associated with the sensor data 704. For example, when the sensor data 704 is an image(s), the input layer may hold values representative of the raw pixel values of the image(s) as a volume (e.g., a width, W, a height, H, and color channels, C (e.g., RGB), such as 32.times.32.times.3), and/or a batch size, B (e.g., where batching is used).

One or more layers 706 may include convolutional layers. The convolutional layers may compute the output of neurons that are connected to local regions in an input layer (e.g., the input layer), each neuron computing a dot product between their weights and a small region they are connected to in the input volume. A result of a convolutional layer may be another volume, with one of the dimensions based on the number of filters applied (e.g., the width, the height, and the number of filters, such as 32×32×12, if 12 were the number of filters).

One or more of the layers 706 may include a rectified linear unit (ReLU) layer. The ReLU layer(s) may apply an elementwise activation function, such as the max (0, x), thresholding at zero, for example. The resulting volume of a ReLU layer may be the same as the volume of the input of the ReLU layer.

One or more of the layers 706 may include a pooling layer. The pooling layer may perform a down-sampling operation along the spatial dimensions (e.g., the height and the width), which may result in a smaller volume than the input of the pooling layer (e.g., 16×16×12 from the 32×32×12 input volume). In some examples, the machine learning model(s) 702 may not include any pooling layers. In such examples, other types of convolution layers may be used in place of pooling layers. In some examples, the feature extractor layer(s) 706 may include alternating convolutional layers and pooling layers.

One or more of the layers 706 may include a fully connected layer. Each neuron in the fully connected layer(s) may be connected to each of the neurons in the previous volume. The fully connected layer may compute class scores, and the resulting volume may be 1×1×N (where N is a number of classes). In some examples, the feature extractor layer(s) 706 may include a fully connected layer, while in other examples, the fully connected layer of the machine learning model(s) 702 may be the fully connected layer separate from the feature extractor layer(s) 706. In some examples, no fully connected layers may be used by the feature extractor layer(s) 706 and/or the machine learning model(s) 702 as a whole, in an effort to increase processing times and reduce computing resource requirements. In such examples, where no fully connected layers are used, the machine learning model(s) 702 may be referred to as a fully convolutional network.

One or more of the layers 706 may, in some examples, include deconvolutional layer(s). However, the use of the term deconvolutional may be misleading and is not intended to be limiting. For example, the deconvolutional layer(s) may alternatively be referred to as transposed convolutional layers or fractionally strided convolutional layers. The deconvolutional layer(s) may be used to perform up-sampling on the output of a prior layer. For example, the deconvolutional layer(s) may be used to up-sample to a spatial resolution that is equal to the spatial resolution of the input images (e.g., the sensor data 704) to the machine learning model(s) 702, or used to up-sample to the input spatial resolution of a next layer.

Although input layers, convolutional layers, pooling layers, ReLU layers, deconvolutional layers, and fully connected layers are discussed herein with respect to the feature extractor layer(s) 706, this is not intended to be limiting. For example, additional or alternative layers 706 may be used in the feature extractor layer(s) 706, such as normalization layers, SoftMax layers, and/or other layer types.

The output of the feature extractor layer(s) 706 may be an input to one or more boundary layers 708, one or more height layers 710, and/or one or more uncertainty layers 712. The boundary layer(s) 708, the height layer(s) 710, and/or the uncertainty layer(s) 712 may use one or more of the layer types described herein with respect to the feature extractor layer(s) 706. As described herein, the boundary layer(s) 708, the height layer(s) 710, and/or the uncertainty layer(s) 712 may not include any fully connected layers, in some examples, to reduce processing speeds and decrease computing resource requirements. In such examples, the boundary layer(s) 708, the height layer(s) 710, and/or the uncertainty layer(s) 712 may be referred to as fully convolutional layers.

Different orders and numbers of the layers 706, 708, 710, and 712 of the machine learning model(s) 702 may be used, depending on the example. For example, where two or more cameras or other sensor types are used to generate inputs, there may be a different order and number of layers 706, 708, 710, and 712 for one or more of the sensors. As another example, different ordering and numbering of layers may be used depending on the type of sensor used to generate the sensor data 704, or the type of the sensor data 704 (e.g., RGB, YUV, etc.). As such, the order and number of layers 706, 708 710, and 712 of the machine learning model(s) 702 is not limited to any one architecture.

In addition, some of the layers 706, 708, 710, and 712 may include parameters (e.g., weights and/or biases)—such as the feature extractor layer(s) 706, the boundary layer(s) 708, the height layer(s) 710, and/or the uncertainty layer(s) 712—while others may not, such as the ReLU layers and pooling layers, for example. In some examples, the parameters may be learned by the machine learning model(s) 702 during training. Further, some of the layers 706, 708, 710, and 712 may include additional hyper-parameters (e.g., learning rate, stride, epochs, kernel size, number of filters, type of pooling for pooling layers, etc.)—such as the convolutional layer(s), the deconvolutional layer(s), and the pooling layer(s)—while other layers may not, such as the ReLU layer(s). Various activation functions may be used, including but not limited to, ReLU, leaky ReLU, sigmoid, hyperbolic tangent (tan h), exponential linear unit (ELU), etc. The parameters, hyper-parameters, and/or activation functions are not to be limited and may differ depending on the embodiment.

In any example, the boundary layer(s) 708 may be configured to output boundary data 714, the height layer(s) 710 may be configured to output height data 716, and/or the uncertainty layer(s) 712 may be configured to output uncertainty data 718, which may respectively be similar to and/or represent the boundary data 110, the height data 112, and/or the uncertainty data 114.

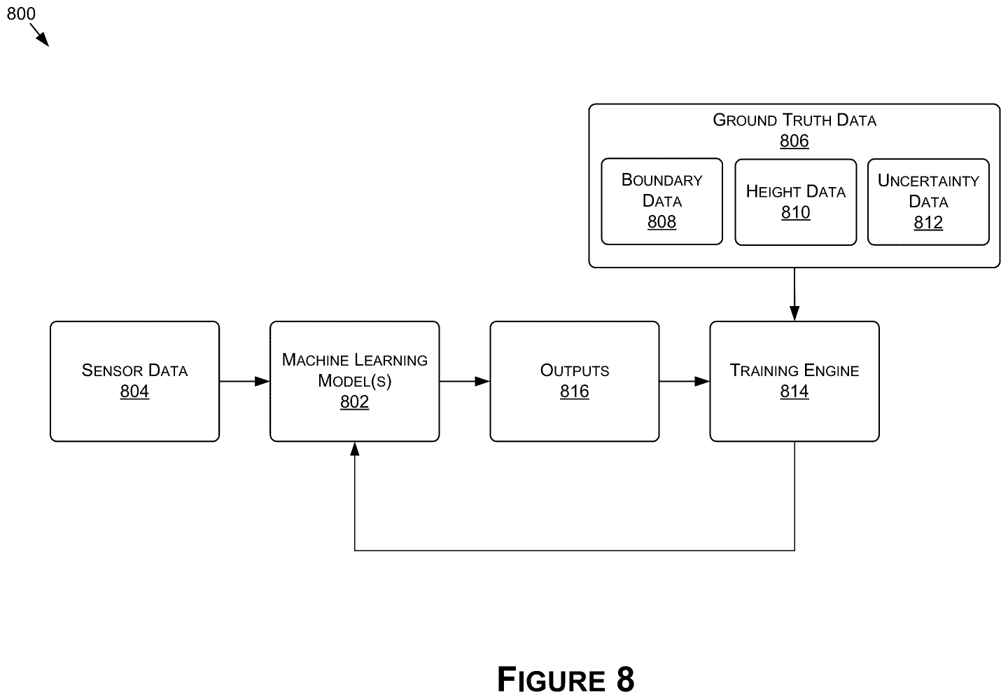

As described herein, in order to generate the data (e.g., the boundary data 110, the height data 112, and/or the uncertainty data 114), the machine learning model(s) 108 may be trained, such as by training different channels of the machine learning model(s) 108. For instance, FIG. 8 is a data flow diagram illustrating a process 800 for training one or more machine learning models 802 (which may represent, and/or include, the machine learning model(s) 108) to determine locations of object boundaries, in accordance with some embodiments of the present disclosure. As shown, the machine learning model(s) 802 may be trained using sensor data 804. In some examples, the sensor data 802 may be similar to the sensor data 104 later used by the machine learning model(s) 802 when performing one or more of the processes described herein. For instance, the sensor data 804 may include, but is not limited to, image data generated using one or more images sensors, LiDAR data generated using one or more LiDAR sensors, ultrasonic data generated using one or more ultrasonic sensors, RADAR data generated using one or more RADAR sensors, and/or any other type of image data generated using any other type of sensor.

The machine learning model(s) 802 may be trained using the training sensor data 804 as well as corresponding ground truth data 806. The ground truth data 806 may include annotations, labels, masks, and/or the like. For instance, in some examples, the ground truth data 806 may include at least boundary data 808, height data 810, and/or uncertainty data 812, which may respectively be similar to the boundary data 110, the height data 112, and/or the uncertainty data 114. As described herein, the ground truth data 806 may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines the location of the labels), and/or a combination thereof. In some examples, for each instance of the sensor data 804, there may be corresponding ground truth data 806.

For instance, in some examples, the ground truth boundary data 808 may include instances of data representing confidence values in various directions with respect to one or more machines. In such examples, the instances of data may be generated using one or more techniques. For a first example, an instance of data may be generated such that every confidence value along the distances and in the direction includes a minimum value (e.g., 0) except for the confidence value associated with the distance to the object boundary that includes a maximum value (e.g., 1). For a second example, blurring may be used on the instance of data. For instance, the distance to the object boundary may again be associated with a maximum confidence value (e.g., 1), however, distances proximate to the object boundary may be associated with confidence values that vary between the minimum confidence value (e.g., 0) and the maximum confidence value. Furthermore, distances that are further from the object boundary may be associated with lower confidence values, such as the minimum confidence value. As such, the machine learning model(s) 802 may be trained to generate instances of data similar to the instances of data 302(1)-(2).

A training engine 814 may use one or more loss functions that measure loss (e.g., error) in outputs 816 (which may also represent boundary data, height data, and/or uncertainty data) as compared to the ground truth data 806. Any type of loss function may be used, such as cross entropy loss, mean squared error, mean absolute error, mean bias error, and/or other loss function types. In some examples, different outputs 816 may have different loss functions. For example, a first loss function may be used to determine a first loss based at least on the boundary data represented by the outputs 816 and the boundary data 808, a second loss function may be used to determine a second loss based at least on the height data represented by the outputs 816 and the height data 810, and/or a third loss function may be used to determine a third loss based at least on the uncertainty data represented by the outputs 816 and the uncertainty data 812. In such examples, the loss functions may be combined to form a total loss, and the total loss may be used to train (e.g., update the parameters of) the machine learning model(s) 802. In any example, backward pass computations may be performed to recursively compute gradients of the loss function(s) with respect to training parameters. In some examples, weights and biases of the machine learning model(s) 802 may be used to compute these gradients.

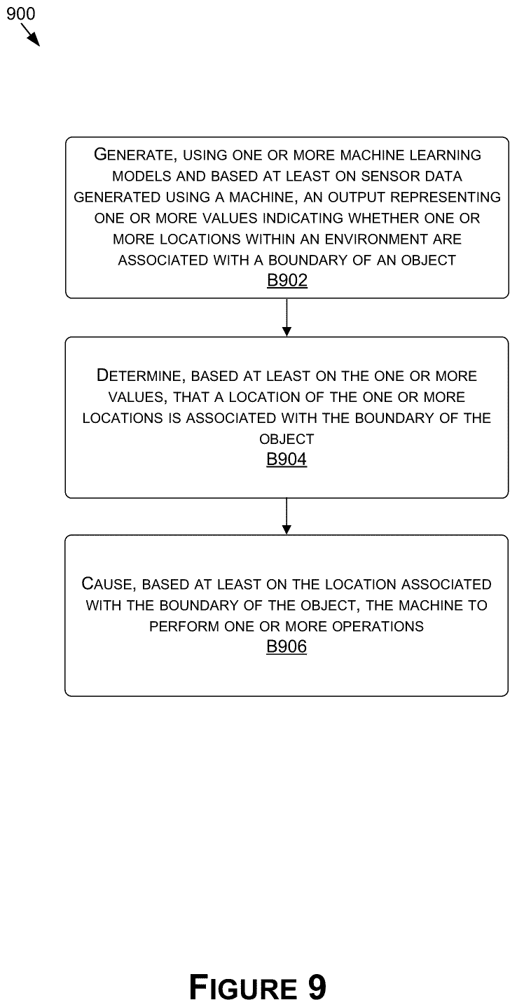

Now referring to FIGS. 9-11, each block of methods 900, 1000, and 1100 described herein, comprises a computing process that may be performed using any combination of hardware, firmware, and/or software. For instance, various functions may be carried out by a processor executing instructions stored in memory. The methods 900, 1000, and 1100 may also be embodied as computer-usable instructions stored on computer storage media. The methods 900, 1000, and 1100 may be provided by a standalone application, a service or hosted service (standalone or in combination with another hosted service), or a plug-in to another product, to name a few. In addition, the methods 900, 1000, and 1100 are described, by way of example, with respect to FIG. 1. However, these methods 900, 1000, and 1100 may additionally or alternatively be executed by any one system, or any combination of systems, including, but not limited to, those described herein.

FIG. 9 illustrates a flow diagram showing a method 900 for determining a location associated with an object boundary, in accordance with some embodiments of the present disclosure. The method 900, at block B902, may include determining, using one or more machine learning models and based at least on sensor data generated using a machine, an output representing one or more values indicating whether one or more locations within an environment are associated with a boundary of an object. For instance, the boundary component 102 may input the sensor data 104 generated using the machine 106 into the machine learning model(s) 108. The machine learning model(s) 108 may be trained to generate at least the boundary data 110 representing the value(s) indicating whether the location(s) within the environment is associated with the object boundary. In some examples, the machine learning model(s) 108 may further be trained to generate the height data 112 and/or the uncertainty data 114 associated with the environment.

The method 900, at block B904, may include determining, based at least on the one or more values, that a location of the one or more locations is associated with the boundary of the object. For instance, the boundary component 102 may use the boundary data 110 to determine that a location is associated with the object boundary (e.g., the location associated with a specific confidence value, such as the maximum confidence value). In some examples, the machine learning model(s) 108 is trained to make the determination using the boundary data 110. In some examples, the mapping component 116 may be configured to perform additional processing on the boundary data 110 to make the determination. Still, in some examples, the machine learning model(s) 108 and/or the mapping component 116 may make the determination further using the height data 112 and/or the uncertainty data 114.

The method 900, at block B906, may include causing, based at least on the location associated with the boundary of the object, the machine to perform one or more operations. For instance, the boundary component 102 may generate the map data 118 representing the obstacle map, where the obstacle map indicates at least the location associated with the object boundary. The boundary component 102 may then provide the machine 106 with the map data 118 such that the machine 106 is able to determine the operation(s) using the map data 118. For instance, the machine 106 may determine one or more paths to navigate in order to avoid a collision with the object.

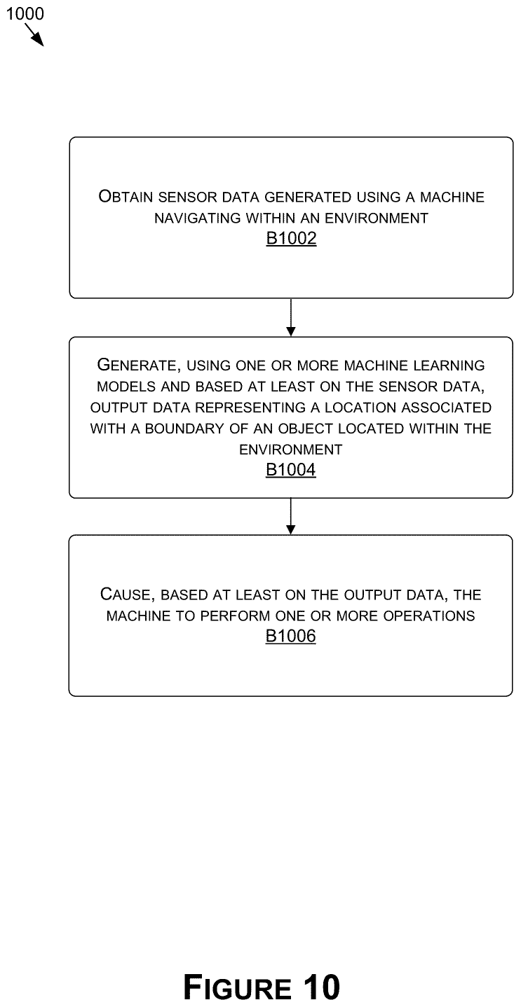

FIG. 10 illustrates a flow diagram showing another method 1000 for determining a location associated with an object boundary, in accordance with some embodiments of the present disclosure. The method 1000, at block B1002, may include obtaining sensor data generated using a machine navigating within an environment. For instance, the boundary component 102 may obtain the sensor data 104 generated using the machine 106 navigating within the environment. As described herein, in some examples, the boundary component 102 may be internal to the machine 106. In some examples, the boundary component 102 may be external to the machine 106 and receive the sensor data 104 using one or more networks.

The method 1000, at block B1004, may include generating, using one or more machine learning models and based at least on the sensor data, output data representing a location associated with a boundary of an object located within the environment. For instance, the boundary component 102 may input the sensor data 104 into the machine learning model(s) 108. The machine learning model(s) 108 may process the sensor data 104 and, based at least on the processing, generate the boundary data 110 associated with the environment. As described herein, the boundary data 110 may represent a grid map representing confidence values associated with the object boundary, an instance of data representing confidence values associated with the object boundary, an obstacle map (e.g., the map data 118), and/or any other type of information indicating the location associated with the object boundary.

The method 1000, at block B1006, may include causing, based at least on the output data, the machine to perform one or more operations. For instance, the boundary component 102 may provide the machine 106 with the boundary data 110 and/or the map data 118. The machine 106 may then determine the operation(s) using the boundary data 110 and/or the map data 118. For instance, the machine 106 may determine one or more paths to navigate in order to avoid a collision with the object.

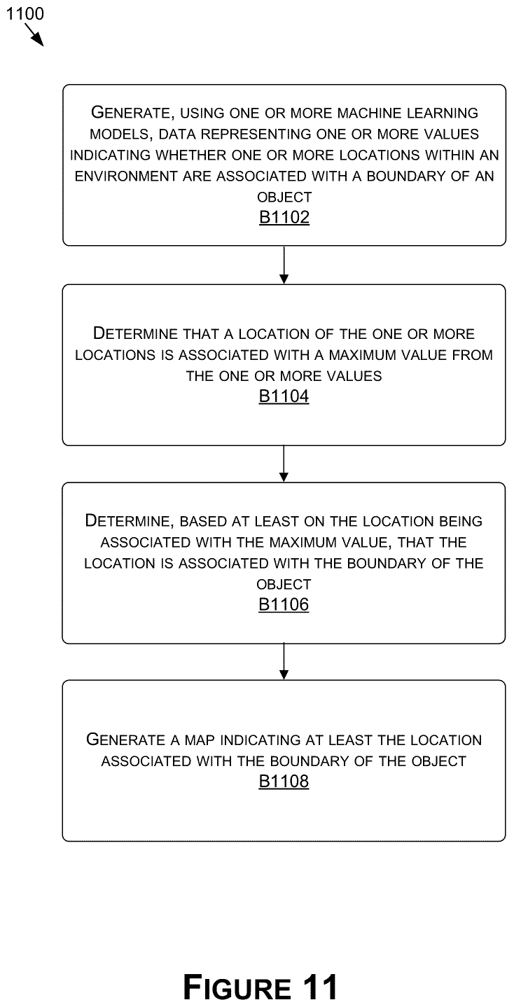

FIG. 11 illustrates another flow diagram showing another method 1100 for determining a location associated with an object boundary, in accordance with some embodiments of the present disclosure. The method 1100, at block B1102, may include generating, using one or more machine learning models, data representing one or more values indicating whether one or more locations within an environment are associated with a boundary of an object. For instance, the boundary component 102 may input the sensor data 104 into the machine learning model(s) 108. The machine learning model(s) 108 may then be trained to generate the boundary data 110 representing the value(s) indicating whether the location(s) within the environment is associated with the object boundary. As described herein, in some examples, the machine learning model(s) 108 may further be trained to generate the height data 112 and/or the uncertainty data 114.

The method 1100, at block B1104, may include determining that a location of the one or more locations is associated with a maximum value of the one or more values. For instance, the boundary component 102 (e.g., the machine learning model(s) 108, the mapping component 116, etc.) may determine that the location is associated with the maximum value. In some examples, such as when the boundary data 110 represents an instance of data, the boundary component 102 may determine the location based at least on a distance from the machine 106 that is associated with the maximum value and in a direction associated with the instance of data. In some examples, such as when the boundary data 110 represents the grid map, the boundary component 102 may determine the location as corresponding to a portion (e.g., a pixel) of the grid map that is associated with the maximum value.

The method 1100, at block B1106, may include determining, based at least on the location being associated with the maximum value, that the location is associated with the boundary of the object. For instance, the boundary component 102 (e.g., the machine learning model(s) 108, the mapping component 116, etc.) may determine that the location is associated with the object boundary based at least on the location being associated with the maximum value. In some examples, the boundary component 102 may make the determination using additional data, such as the height data 112 and/or the uncertainty data 114.

The method 1100, at block B1108, may include generating a map indicating at least the location associated with the boundary of the object. For instance, the boundary component 102 (e.g., the machine learning model(s) 108, the mapping component 116, etc.) may generate the map data 118 representing the obstacle map that indicates at least the location associated with the object boundary.

### Example Autonomous Vehicle

FIG. 12A is an illustration of an example autonomous vehicle 1200, in accordance with some embodiments of the present disclosure. The autonomous vehicle 1200 (alternatively referred to herein as the “vehicle 1200”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 1200 may be capable of functionality in accordance with one or more of Level 3-Level 5 of the autonomous driving levels. The vehicle 1200 may be capable of functionality in accordance with one or more of Level 1-Level 5 of the autonomous driving levels. For example, the vehicle 1200 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 1200 or other machine, such as being fully autonomous, being highly autonomous, being conditionally autonomous, being partially autonomous, providing assistive autonomy, being semi-autonomous, being primarily autonomous, or other designation.

The vehicle 1200 may include components such as a chassis, a vehicle body, wheels (e.g., 2, 4, 6, 8, 18, etc.), tires, axles, and other components of a vehicle. The vehicle 1200 may include a propulsion system 1250, such as an internal combustion engine, hybrid electric power plant, an all-electric engine, and/or another propulsion system type. The propulsion system 1250 may be connected to a drive train of the vehicle 1200, which may include a transmission, to enable the propulsion of the vehicle 1200. The propulsion system 1250 may be controlled in response to receiving signals from the throttle/accelerator 1252.

A steering system 1254, which may include a steering wheel, may be used to steer the vehicle 1200 (e.g., along a desired path or route) when the propulsion system 1250 is operating (e.g., when the vehicle is in motion). The steering system 1254 may receive signals from a steering actuator 1256. The steering wheel may be optional for full automation (Level 5) functionality.

The brake sensor system 1246 may be used to operate the vehicle brakes in response to receiving signals from the brake actuators 1248 and/or brake sensors.

Controller(s) 1236, which may include one or more system on chips (SoCs) 1204 (FIG. 12C) and/or GPU(s), may provide signals (e.g., representative of commands) to one or more components and/or systems of the vehicle 1200. For example, the controller(s) may send signals to operate the vehicle brakes via one or more brake actuators 1248, to operate the steering system 1254 via one or more steering actuators 1256, to operate the propulsion system 1250 via one or more throttle/accelerators 1252. The controller(s) 1236 may include one or more onboard (e.g., integrated) computing devices (e.g., supercomputers) that process sensor signals, and output operation commands (e.g., signals representing commands) to enable autonomous driving and/or to assist a human driver in driving the vehicle 1200. The controller(s) 1236 may include a first controller 1236 for autonomous driving functions, a second controller 1236 for functional safety functions, a third controller 1236 for artificial intelligence functionality (e.g., computer vision), a fourth controller 1236 for infotainment functionality, a fifth controller 1236 for redundancy in emergency conditions, and/or other controllers. In some examples, a single controller 1236 may handle two or more of the above functionalities, two or more controllers 1236 may handle a single functionality, and/or any combination thereof.

The controller(s) 1236 may provide the signals for controlling one or more components and/or systems of the vehicle 1200 in response to sensor data received from one or more sensors (e.g., sensor inputs). The sensor data may be received from, for example and without limitation, global navigation satellite systems (“GNSS”) sensor(s) 1258 (e.g., Global Positioning System sensor(s)), RADAR sensor(s) 1260, ultrasonic sensor(s) 1262, LIDAR sensor(s) 1264, inertial measurement unit (IMU) sensor(s) 1266 (e.g., accelerometer(s), gyroscope(s), magnetic compass(es), magnetometer(s), etc.), microphone(s) 1296, stereo camera(s) 1268, wide-view camera(s) 1270 (e.g., fisheye cameras), infrared camera(s) 1272, surround camera(s) 1274 (e.g., 360 degree cameras), long-range and/or mid-range camera(s) 1298, speed sensor(s) 1244 (e.g., for measuring the speed of the vehicle 1200), vibration sensor(s) 1242, steering sensor(s) 1240, brake sensor(s) (e.g., as part of the brake sensor system 1246), and/or other sensor types.

One or more of the controller(s) 1236 may receive inputs (e.g., represented by input data) from an instrument cluster 1232 of the vehicle 1200 and provide outputs (e.g., represented by output data, display data, etc.) via a human-machine interface (HMI) display 1234, an audible annunciator, a loudspeaker, and/or via other components of the vehicle 1200. The outputs may include information such as vehicle velocity, speed, time, map data (e.g., the High Definition (“HD”) map 1222 of FIG. 12C), location data (e.g., the vehicle's 1200 location, such as on a map), direction, location of other vehicles (e.g., an occupancy grid), information about objects and status of objects as perceived by the controller(s) 1236, etc. For example, the HMI display 1234 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 1200 further includes a network interface 1224 which may use one or more wireless antenna(s) 1226 and/or modem(s) to communicate over one or more networks. For example, the network interface 1224 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 1226 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 12B is an example of camera locations and fields of view for the example autonomous vehicle 1200 of FIG. 12A, in accordance with some embodiments of the present disclosure. The cameras and respective fields of view are one example embodiment and are not intended to be limiting. For example, additional and/or alternative cameras may be included and/or the cameras may be located at different locations on the vehicle 1200.

The camera types for the cameras may include, but are not limited to, digital cameras that may be adapted for use with the components and/or systems of the vehicle 1200. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 1200 (e.g., front-facing cameras) may be used for surround view, to help identify forward facing paths and objects, as well aid in, with the help of one or more controllers 1236 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 1270 that may be used to perceive objects coming into view from the periphery (e.g., pedestrians, crossing traffic or bicycles). Although only one wide-view camera is illustrated in FIG. 12B, there may be any number (including zero) of wide-view cameras 1270 on the vehicle 1200. In addition, any number of long-range camera(s) 1298 (e.g., a long-view stereo camera pair) may be used for depth-based object detection, especially for objects for which a neural network has not yet been trained. The long-range camera(s) 1298 may also be used for object detection and classification, as well as basic object tracking.

Any number of stereo cameras 1268 may also be included in a front-facing configuration. In at least one embodiment, one or more of stereo camera(s) 1268 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 1268 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 1268 may be used in addition to, or alternatively from, those described herein.

Cameras with a field of view that include portions of the environment to the side of the vehicle 1200 (e.g., side-view cameras) may be used for surround view, providing information used to create and update the occupancy grid, as well as to generate side impact collision warnings. For example, surround camera(s) 1274 (e.g., four surround cameras 1274 as illustrated in FIG. 12B) may be positioned to on the vehicle 1200. The surround camera(s) 1274 may include wide-view camera(s) 1270, fisheye camera(s), 360 degree camera(s), and/or the like. Four example, four fisheye cameras may be positioned on the vehicle's front, rear, and sides. In an alternative arrangement, the vehicle may use three surround camera(s) 1274 (e.g., left, right, and rear), and may leverage one or more other camera(s) (e.g., a forward-facing camera) as a fourth surround view camera.

Cameras with a field of view that include portions of the environment to the rear of the vehicle 1200 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 1298, stereo camera(s) 1268), infrared camera(s) 1272, etc.), as described herein.

FIG. 12C is a block diagram of an example system architecture for the example autonomous vehicle 1200 of FIG. 12A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 1200 in FIG. 12C are illustrated as being connected via bus 1202. The bus 1202 may include a Controller Area Network (CAN) data interface (alternatively referred to herein as a “CAN bus”). A CAN may be a network inside the vehicle 1200 used to aid in control of various features and functionality of the vehicle 1200, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 1202 is described herein as being a CAN bus, this is not intended to be limiting. For example, in addition to, or alternatively from, the CAN bus, FlexRay and/or Ethernet may be used. Additionally, although a single line is used to represent the bus 1202, this is not intended to be limiting. For example, there may be any number of busses 1202, which may include one or more CAN busses, one or more FlexRay busses, one or more Ethernet busses, and/or one or more other types of busses using a different protocol. In some examples, two or more busses 1202 may be used to perform different functions, and/or may be used for redundancy. For example, a first bus 1202 may be used for collision avoidance functionality and a second bus 1202 may be used for actuation control. In any example, each bus 1202 may communicate with any of the components of the vehicle 1200, and two or more busses 1202 may communicate with the same components. In some examples, each SoC 1204, each controller 1236, and/or each computer within the vehicle may have access to the same input data (e.g., inputs from sensors of the vehicle 1200), and may be connected to a common bus, such the CAN bus.

The vehicle 1200 may include one or more controller(s) 1236, such as those described herein with respect to FIG. 12A. The controller(s) 1236 may be used for a variety of functions. The controller(s) 1236 may be coupled to any of the various other components and systems of the vehicle 1200, and may be used for control of the vehicle 1200, artificial intelligence of the vehicle 1200, infotainment for the vehicle 1200, and/or the like.

The vehicle 1200 may include a system(s) on a chip (SoC) 1204. The SoC 1204 may include CPU(s) 1206, GPU(s) 1208, processor(s) 1210, cache(s) 1212, accelerator(s) 1214, data store(s) 1216, and/or other components and features not illustrated. The SoC(s) 1204 may be used to control the vehicle 1200 in a variety of platforms and systems. For example, the SoC(s) 1204 may be combined in a system (e.g., the system of the vehicle 1200) with an HD map 1222 which may obtain map refreshes and/or updates via a network interface 1224 from one or more servers (e.g., server(s) 1278 of FIG. 12D).

The CPU(s) 1206 may include a CPU cluster or CPU complex (alternatively referred to herein as a “CCPLEX”). The CPU(s) 1206 may include multiple cores and/or L2 caches. For example, in some embodiments, the CPU(s) 1206 may include eight cores in a coherent multi-processor configuration. In some embodiments, the CPU(s) 1206 may include four dual-core clusters where each cluster has a dedicated L2 cache (e.g., a 2 MB L2 cache). The CPU(s) 1206 (e.g., the CCPLEX) may be configured to support simultaneous cluster operation enabling any combination of the clusters of the CPU(s) 1206 to be active at any given time.

The CPU(s) 1206 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 1206 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 1208 may include an integrated GPU (alternatively referred to herein as an “iGPU”). The GPU(s) 1208 may be programmable and may be efficient for parallel workloads. The GPU(s) 1208, in some examples, may use an enhanced tensor instruction set. The GPU(s) 1208 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 1208 may include at least eight streaming microprocessors. The GPU(s) 1208 may use compute application programming interface(s) (API(s)). In addition, the GPU(s) 1208 may use one or more parallel computing platforms and/or programming models (e.g., NVIDIA's CUDA).

The GPU(s) 1208 may be power-optimized for best performance in automotive and embedded use cases. For example, the GPU(s) 1208 may be fabricated on a Fin field-effect transistor (FinFET). However, this is not intended to be limiting and the GPU(s) 1208 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 1208 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 1208 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 1208 to access the CPU(s) 1206 page tables directly. In such examples, when the GPU(s) 1208 memory management unit (MMU) experiences a miss, an address translation request may be transmitted to the CPU(s) 1206. In response, the CPU(s) 1206 may look in its page tables for the virtual-to-physical mapping for the address and transmits the translation back to the GPU(s) 1208. As such, unified memory technology may allow a single unified virtual address space for memory of both the CPU(s) 1206 and the GPU(s) 1208, thereby simplifying the GPU(s) 1208 programming and porting of applications to the GPU(s) 1208.

In addition, the GPU(s) 1208 may include an access counter that may keep track of the frequency of access of the GPU(s) 1208 to memory of other processors. The access counter may help ensure that memory pages are moved to the physical memory of the processor that is accessing the pages most frequently.

The SoC(s) 1204 may include any number of cache(s) 1212, including those described herein. For example, the cache(s) 1212 may include an L3 cache that is available to both the CPU(s) 1206 and the GPU(s) 1208 (e.g., that is connected both the CPU(s) 1206 and the GPU(s) 1208). The cache(s) 1212 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 1204 may include an arithmetic logic unit(s) (ALU(s)) which may be leveraged in performing processing with respect to any of the variety of tasks or operations of the vehicle 1200—such as processing DNNs. In addition, the SoC(s) 1204 may include a floating point unit(s) (FPU(s))—or other math coprocessor or numeric coprocessor types—for performing mathematical operations within the system. For example, the SoC(s) 1204 may include one or more FPUs integrated as execution units within a CPU(s) 1206 and/or GPU(s) 1208.

The SoC(s) 1204 may include one or more accelerators 1214 (e.g., hardware accelerators, software accelerators, or a combination thereof). For example, the SoC(s) 1204 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 1208 and to off-load some of the tasks of the GPU(s) 1208 (e.g., to free up more cycles of the GPU(s) 1208 for performing other tasks). As an example, the accelerator(s) 1214 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 1214 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 1208, and by using an inference accelerator, for example, a designer may target either the DLA(s) or the GPU(s) 1208 for any function. For example, the designer may focus processing of CNNs and floating point operations on the DLA(s) and leave other functions to the GPU(s) 1208 and/or other accelerator(s) 1214.

The accelerator(s) 1214 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 1206. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 1214 (e.g., the hardware acceleration cluster) may include a computer vision network on-chip and SRAM, for providing a high-bandwidth, low latency SRAM for the accelerator(s) 1214. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 1204 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 1214 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 1266 output that correlates with the vehicle 1200 orientation, distance, 3D location estimates of the object obtained from the neural network and/or other sensors (e.g., LIDAR sensor(s) 1264 or RADAR sensor(s) 1260), among others.

The SoC(s) 1204 may include data store(s) 1216 (e.g., memory). The data store(s) 1216 may be on-chip memory of the SoC(s) 1204, which may store neural networks to be executed on the GPU and/or the DLA. In some examples, the data store(s) 1216 may be large enough in capacity to store multiple instances of neural networks for redundancy and safety. The data store(s) 1212 may comprise L2 or L3 cache(s) 1212. Reference to the data store(s) 1216 may include reference to the memory associated with the PVA, DLA, and/or other accelerator(s) 1214, as described herein.

The SoC(s) 1204 may include one or more processor(s) 1210 (e.g., embedded processors). The processor(s) 1210 may include a boot and power management processor that may be a dedicated processor and subsystem to handle boot power and management functions and related security enforcement. The boot and power management processor may be a part of the SoC(s) 1204 boot sequence and may provide runtime power management services. The boot power and management processor may provide clock and voltage programming, assistance in system low power state transitions, management of SoC(s) 1204 thermals and temperature sensors, and/or management of the SoC(s) 1204 power states. Each temperature sensor may be implemented as a ring-oscillator whose output frequency is proportional to temperature, and the SoC(s) 1204 may use the ring-oscillators to detect temperatures of the CPU(s) 1206, GPU(s) 1208, and/or accelerator(s) 1214. If temperatures are determined to exceed a threshold, the boot and power management processor may enter a temperature fault routine and put the SoC(s) 1204 into a lower power state and/or put the vehicle 1200 into a chauffeur to safe stop mode (e.g., bring the vehicle 1200 to a safe stop).

The processor(s) 1210 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 1210 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 1210 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 1210 may further include a real-time camera engine that may include a dedicated processor subsystem for handling real-time camera management.

The processor(s) 1210 may further include a high-dynamic range signal processor that may include an image signal processor that is a hardware engine that is part of the camera processing pipeline.

The processor(s) 1210 may include a video image compositor that may be a processing block (e.g., implemented on a microprocessor) that implements video post-processing functions needed by a video playback application to produce the final image for the player window. The video image compositor may perform lens distortion correction on wide-view camera(s) 1270, surround camera(s) 1274, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 1208 is not required to continuously render new surfaces. Even when the GPU(s) 1208 is powered on and active doing 3D rendering, the video image compositor may be used to offload the GPU(s) 1208 to improve performance and responsiveness.

The SoC(s) 1204 may further include a mobile industry processor interface (MIPI) camera serial interface for receiving video and input from cameras, a high-speed interface, and/or a video input block that may be used for camera and related pixel input functions. The SoC(s) 1204 may further include an input/output controller(s) that may be controlled by software and may be used for receiving I/O signals that are uncommitted to a specific role.

The SoC(s) 1204 may further include a broad range of peripheral interfaces to enable communication with peripherals, audio codecs, power management, and/or other devices. The SoC(s) 1204 may be used to process data from cameras (e.g., connected over Gigabit Multimedia Serial Link and Ethernet), sensors (e.g., LIDAR sensor(s) 1264, RADAR sensor(s) 1260, etc. that may be connected over Ethernet), data from bus 1202 (e.g., speed of vehicle 1200, steering wheel position, etc.), data from GNSS sensor(s) 1258 (e.g., connected over Ethernet or CAN bus). The SoC(s) 1204 may further include dedicated high-performance mass storage controllers that may include their own DMA engines, and that may be used to free the CPU(s) 1206 from routine data management tasks.

The SoC(s) 1204 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 1204 may be faster, more reliable, and even more energy-efficient and space-efficient than conventional systems. For example, the accelerator(s) 1214, when combined with the CPU(s) 1206, the GPU(s) 1208, and the data store(s) 1216, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 1220) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 1208.

In some examples, a CNN for facial recognition and vehicle owner identification may use data from camera sensors to identify the presence of an authorized driver and/or owner of the vehicle 1200. The always on sensor processing engine may be used to unlock the vehicle when the owner approaches the driver door and turn on the lights, and, in security mode, to disable the vehicle when the owner leaves the vehicle. In this way, the SoC(s) 1204 provide for security against theft and/or carjacking.

In another example, a CNN for emergency vehicle detection and identification may use data from microphones 1296 to detect and identify emergency vehicle sirens. In contrast to conventional systems, that use general classifiers to detect sirens and manually extract features, the SoC(s) 1204 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 1258. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 1262, until the emergency vehicle(s) passes.

The vehicle may include a CPU(s) 1218 (e.g., discrete CPU(s), or dCPU(s)), that may be coupled to the SoC(s) 1204 via a high-speed interconnect (e.g., PCIe). The CPU(s) 1218 may include an X86 processor, for example. The CPU(s) 1218 may be used to perform any of a variety of functions, including arbitrating potentially inconsistent results between ADAS sensors and the SoC(s) 1204, and/or monitoring the status and health of the controller(s) 1236 and/or infotainment SoC 1230, for example.

The vehicle 1200 may include a GPU(s) 1220 (e.g., discrete GPU(s), or dGPU(s)), that may be coupled to the SoC(s) 1204 via a high-speed interconnect (e.g., NVIDIA's NVLINK). The GPU(s) 1220 may provide additional artificial intelligence functionality, such as by executing redundant and/or different neural networks, and may be used to train and/or update neural networks based on input (e.g., sensor data) from sensors of the vehicle 1200.

The vehicle 1200 may further include the network interface 1224 which may include one or more wireless antennas 1226 (e.g., one or more wireless antennas for different communication protocols, such as a cellular antenna, a Bluetooth antenna, etc.). The network interface 1224 may be used to enable wireless connectivity over the Internet with the cloud (e.g., with the server(s) 1278 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 1200 information about vehicles in proximity to the vehicle 1200 (e.g., vehicles in front of, on the side of, and/or behind the vehicle 1200). This functionality may be part of a cooperative adaptive cruise control functionality of the vehicle 1200.

The network interface 1224 may include a SoC that provides modulation and demodulation functionality and enables the controller(s) 1236 to communicate over wireless networks. The network interface 1224 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 1200 may further include data store(s) 1228 which may include off-chip (e.g., off the SoC(s) 1204) storage. The data store(s) 1228 may include one or more storage elements including RAM, SRAM, DRAM, VRAM, Flash, hard disks, and/or other components and/or devices that may store at least one bit of data.

The vehicle 1200 may further include GNSS sensor(s) 1258. The GNSS sensor(s) 1258 (e.g., GPS, assisted GPS sensors, differential GPS (DGPS) sensors, etc.), to assist in mapping, perception, occupancy grid generation, and/or path planning functions. Any number of GNSS sensor(s) 1258 may be used, including, for example and without limitation, a GPS using a USB connector with an Ethernet to Serial (RS-232) bridge.

The vehicle 1200 may further include RADAR sensor(s) 1260. The RADAR sensor(s) 1260 may be used by the vehicle 1200 for long-range vehicle detection, even in darkness and/or severe weather conditions. RADAR functional safety levels may be ASIL B. The RADAR sensor(s) 1260 may use the CAN and/or the bus 1202 (e.g., to transmit data generated by the RADAR sensor(s) 1260) for control and to access object tracking data, with access to Ethernet to access raw data in some examples. A wide variety of RADAR sensor types may be used. For example, and without limitation, the RADAR sensor(s) 1260 may be suitable for front, rear, and side RADAR use. In some example, Pulse Doppler RADAR sensor(s) are used.

The RADAR sensor(s) 1260 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 1260 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 1200 surroundings at higher speeds with minimal interference from traffic in adjacent lanes. The other two antennae may expand the field of view, making it possible to quickly detect vehicles entering or leaving the vehicle's 1200 lane.

Mid-range RADAR systems may include, as an example, a range of up to 1260 m (front) or 80 m (rear), and a field of view of up to 42 degrees (front) or 1250 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 1200 may further include ultrasonic sensor(s) 1262. The ultrasonic sensor(s) 1262, which may be positioned at the front, back, and/or the sides of the vehicle 1200, may be used for park assist and/or to create and update an occupancy grid. A wide variety of ultrasonic sensor(s) 1262 may be used, and different ultrasonic sensor(s) 1262 may be used for different ranges of detection (e.g., 2.5 m, 4 m). The ultrasonic sensor(s) 1262 may operate at functional safety levels of ASIL B.

The vehicle 1200 may include LIDAR sensor(s) 1264. The LIDAR sensor(s) 1264 may be used for object and pedestrian detection, emergency braking, collision avoidance, and/or other functions. The LIDAR sensor(s) 1264 may be functional safety level ASIL B. In some examples, the vehicle 1200 may include multiple LIDAR sensors 1264 (e.g., two, four, six, etc.) that may use Ethernet (e.g., to provide data to a Gigabit Ethernet switch).

In some examples, the LIDAR sensor(s) 1264 may be capable of providing a list of objects and their distances for a 360-degree field of view. Commercially available LIDAR sensor(s) 1264 may have an advertised range of approximately 1200 m, with an accuracy of 2 cm-3 cm, and with support for a 1200 Mbps Ethernet connection, for example. In some examples, one or more non-protruding LIDAR sensors 1264 may be used. In such examples, the LIDAR sensor(s) 1264 may be implemented as a small device that may be embedded into the front, rear, sides, and/or corners of the vehicle 1200. The LIDAR sensor(s) 1264, in such examples, may provide up to a 120-degree horizontal and 35-degree vertical field-of-view, with a 200 m range even for low-reflectivity objects. Front-mounted LIDAR sensor(s) 1264 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 1200. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 1264 may be less susceptible to motion blur, vibration, and/or shock.

The vehicle may further include IMU sensor(s) 1266. The IMU sensor(s) 1266 may be located at a center of the rear axle of the vehicle 1200, in some examples. The IMU sensor(s) 1266 may include, for example and without limitation, an accelerometer(s), a magnetometer(s), a gyroscope(s), a magnetic compass(es), and/or other sensor types. In some examples, such as in six-axis applications, the IMU sensor(s) 1266 may include accelerometers and gyroscopes, while in nine-axis applications, the IMU sensor(s) 1266 may include accelerometers, gyroscopes, and magnetometers.

In some embodiments, the IMU sensor(s) 1266 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 1266 may enable the vehicle 1200 to estimate heading without requiring input from a magnetic sensor by directly observing and correlating the changes in velocity from GPS to the IMU sensor(s) 1266. In some examples, the IMU sensor(s) 1266 and the GNSS sensor(s) 1258 may be combined in a single integrated unit.

The vehicle may include microphone(s) 1296 placed in and/or around the vehicle 1200. The microphone(s) 1296 may be used for emergency vehicle detection and identification, among other things.

The vehicle may further include any number of camera types, including stereo camera(s) 1268, wide-view camera(s) 1270, infrared camera(s) 1272, surround camera(s) 1274, long-range and/or mid-range camera(s) 1298, and/or other camera types. The cameras may be used to capture image data around an entire periphery of the vehicle 1200. The types of cameras used depends on the embodiments and requirements for the vehicle 1200, and any combination of camera types may be used to provide the necessary coverage around the vehicle 1200. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 12A and FIG. 12B.

The vehicle 1200 may further include vibration sensor(s) 1242. The vibration sensor(s) 1242 may measure vibrations of components of the vehicle, such as the axle(s). For example, changes in vibrations may indicate a change in road surfaces. In another example, when two or more vibration sensors 1242 are used, the differences between the vibrations may be used to determine friction or slippage of the road surface (e.g., when the difference in vibration is between a power-driven axle and a freely rotating axle).

The vehicle 1200 may include an ADAS system 1238. The ADAS system 1238 may include a SoC, in some examples. The ADAS system 1238 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 1260, LIDAR sensor(s) 1264, and/or a camera(s). The ACC systems may include longitudinal ACC and/or lateral ACC. Longitudinal ACC monitors and controls the distance to the vehicle immediately ahead of the vehicle 1200 and automatically adjust the vehicle speed to maintain a safe distance from vehicles ahead. Lateral ACC performs distance keeping, and advises the vehicle 1200 to change lanes when necessary. Lateral ACC is related to other ADAS applications such as LCA and CWS.

CACC uses information from other vehicles that may be received via the network interface 1224 and/or the wireless antenna(s) 1226 from other vehicles via a wireless link, or indirectly, over a network connection (e.g., over the Internet). Direct links may be provided by a vehicle-to-vehicle (V2V) communication link, while indirect links may be infrastructure-to-vehicle (12V) communication link. In general, the V2V communication concept provides information about the immediately preceding vehicles (e.g., vehicles immediately ahead of and in the same lane as the vehicle 1200), while the I2V communication concept provides information about traffic further ahead. CACC systems may include either or both I2V and V2V information sources. Given the information of the vehicles ahead of the vehicle 1200, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 1260, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 1260, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 1200 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 1200 if the vehicle 1200 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 1260, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 1200 is backing up. Some RCTW systems include AEB to ensure that the vehicle brakes are applied to avoid a crash. RCTW systems may use one or more rear-facing RADAR sensor(s) 1260, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 1200, the vehicle 1200 itself must, in the case of conflicting results, decide whether to heed the result from a primary computer or a secondary computer (e.g., a first controller 1236 or a second controller 1236). For example, in some embodiments, the ADAS system 1238 may be a backup and/or secondary computer for providing perception information to a backup computer rationality module. The backup computer rationality monitor may run a redundant diverse software on hardware components to detect faults in perception and dynamic driving tasks. Outputs from the ADAS system 1238 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 1204.

In other examples, ADAS system 1238 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 1238 may be fed into the primary computer's perception block and/or the primary computer's dynamic driving task block. For example, if the ADAS system 1238 indicates a forward crash warning due to an object immediately ahead, the perception block may use this information when identifying objects. In other examples, the secondary computer may have its own neural network which is trained and thus reduces the risk of false positives, as described herein.

The vehicle 1200 may further include the infotainment SoC 1230 (e.g., an in-vehicle infotainment system (IVI)). Although illustrated and described as a SoC, the infotainment system may not be a SoC, and may include two or more discrete components. The infotainment SoC 1230 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 1200. For example, the infotainment SoC 1230 may radios, disk players, navigation systems, video players, USB and Bluetooth connectivity, carputers, in-car entertainment, Wi-Fi, steering wheel audio controls, hands free voice control, a heads-up display (HUD), an HMI display 1234, a telematics device, a control panel (e.g., for controlling and/or interacting with various components, features, and/or systems), and/or other components. The infotainment SoC 1230 may further be used to provide information (e.g., visual and/or audible) to a user(s) of the vehicle, such as information from the ADAS system 1238, autonomous driving information such as planned vehicle maneuvers, trajectories, surrounding environment information (e.g., intersection information, vehicle information, road information, etc.), and/or other information.

The infotainment SoC 1230 may include GPU functionality. The infotainment SoC 1230 may communicate over the bus 1202 (e.g., CAN bus, Ethernet, etc.) with other devices, systems, and/or components of the vehicle 1200. In some examples, the infotainment SoC 1230 may be coupled to a supervisory MCU such that the GPU of the infotainment system may perform some self-driving functions in the event that the primary controller(s) 1236 (e.g., the primary and/or backup computers of the vehicle 1200) fail. In such an example, the infotainment SoC 1230 may put the vehicle 1200 into a chauffeur to safe stop mode, as described herein.

The vehicle 1200 may further include an instrument cluster 1232 (e.g., a digital dash, an electronic instrument cluster, a digital instrument panel, etc.). The instrument cluster 1232 may include a controller and/or supercomputer (e.g., a discrete controller or supercomputer). The instrument cluster 1232 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 1230 and the instrument cluster 1232. In other words, the instrument cluster 1232 may be included as part of the infotainment SoC 1230, or vice versa.

FIG. 12D is a system diagram for communication between cloud-based server(s) and the example autonomous vehicle 1200 of FIG. 12A, in accordance with some embodiments of the present disclosure. The system 1276 may include server(s) 1278, network(s) 1290, and vehicles, including the vehicle 1200. The server(s) 1278 may include a plurality of GPUs 1284(A)-1284(H) (collectively referred to herein as GPUs 1284), PCIe switches 1282(A)-1282(H) (collectively referred to herein as PCIe switches 1282), and/or CPUs 1280(A)-1280(B) (collectively referred to herein as CPUs 1280). The GPUs 1284, the CPUs 1280, and the PCIe switches may be interconnected with high-speed interconnects such as, for example and without limitation, NVLink interfaces 1288 developed by NVIDIA and/or PCIe connections 1286. In some examples, the GPUs 1284 are connected via NVLink and/or NVSwitch SoC and the GPUs 1284 and the PCIe switches 1282 are connected via PCIe interconnects. Although eight GPUs 1284, two CPUs 1280, and two PCIe switches are illustrated, this is not intended to be limiting. Depending on the embodiment, each of the server(s) 1278 may include any number of GPUs 1284, CPUs 1280, and/or PCIe switches. For example, the server(s) 1278 may each include eight, sixteen, thirty-two, and/or more GPUs 1284.

The server(s) 1278 may receive, over the network(s) 1290 and from the vehicles, image data representative of images showing unexpected or changed road conditions, such as recently commenced road-work. The server(s) 1278 may transmit, over the network(s) 1290 and to the vehicles, neural networks 1292, updated neural networks 1292, and/or map information 1294, including information regarding traffic and road conditions. The updates to the map information 1294 may include updates for the HD map 1222, such as information regarding construction sites, potholes, detours, flooding, and/or other obstructions. In some examples, the neural networks 1292, the updated neural networks 1292, and/or the map information 1294 may have resulted from new training and/or experiences represented in data received from any number of vehicles in the environment, and/or based on training performed at a datacenter (e.g., using the server(s) 1278 and/or other servers).

The server(s) 1278 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 1290, and/or the machine learning models may be used by the server(s) 1278 to remotely monitor the vehicles.

In some examples, the server(s) 1278 may receive data from the vehicles and apply the data to up-to-date real-time neural networks for real-time intelligent inferencing. The server(s) 1278 may include deep-learning supercomputers and/or dedicated AI computers powered by GPU(s) 1284, such as a DGX and DGX Station machines developed by NVIDIA. However, in some examples, the server(s) 1278 may include deep learning infrastructure that use only CPU-powered datacenters.

The deep-learning infrastructure of the server(s) 1278 may be capable of fast, real-time inferencing, and may use that capability to evaluate and verify the health of the processors, software, and/or associated hardware in the vehicle 1200. For example, the deep-learning infrastructure may receive periodic updates from the vehicle 1200, such as a sequence of images and/or objects that the vehicle 1200 has located in that sequence of images (e.g., via computer vision and/or other machine learning object classification techniques). The deep-learning infrastructure may run its own neural network to identify the objects and compare them with the objects identified by the vehicle 1200 and, if the results do not match and the infrastructure concludes that the AI in the vehicle 1200 is malfunctioning, the server(s) 1278 may transmit a signal to the vehicle 1200 instructing a fail-safe computer of the vehicle 1200 to assume control, notify the passengers, and complete a safe parking maneuver.

For inferencing, the server(s) 1278 may include the GPU(s) 1284 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 13 is a block diagram of an example computing device(s) 1300 suitable for use in implementing some embodiments of the present disclosure. Computing device 1300 may include an interconnect system 1302 that directly or indirectly couples the following devices: memory 1304, one or more central processing units (CPUs) 1306, one or more graphics processing units (GPUs) 1308, a communication interface 1310, input/output (I/O) ports 1312, input/output components 1314, a power supply 1316, one or more presentation components 1318 (e.g., display(s)), and one or more logic units 1320. In at least one embodiment, the computing device(s) 1300 may comprise one or more virtual machines (VMs), and/or any of the components thereof may comprise virtual components (e.g., virtual hardware components). For non-limiting examples, one or more of the GPUs 1308 may comprise one or more vGPUs, one or more of the CPUs 1306 may comprise one or more vCPUs, and/or one or more of the logic units 1320 may comprise one or more virtual logic units. As such, a computing device(s) 1300 may include discrete components (e.g., a full GPU dedicated to the computing device 1300), virtual components (e.g., a portion of a GPU dedicated to the computing device 1300), or a combination thereof.

Although the various blocks of FIG. 13 are shown as connected via the interconnect system 1302 with lines, this is not intended to be limiting and is for clarity only. For example, in some embodiments, a presentation component 1318, such as a display device, may be considered an I/O component 1314 (e.g., if the display is a touch screen). As another example, the CPUs 1306 and/or GPUs 1308 may include memory (e.g., the memory 1304 may be representative of a storage device in addition to the memory of the GPUs 1308, the CPUs 1306, and/or other components). In other words, the computing device of FIG. 13 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 13.

The interconnect system 1302 may represent one or more links or busses, such as an address bus, a data bus, a control bus, or a combination thereof. The interconnect system 1302 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1306 may be directly connected to the memory 1304. Further, the CPU 1306 may be directly connected to the GPU 1308. Where there is direct, or point-to-point connection between components, the interconnect system 1302 may include a PCIe link to carry out the connection. In these examples, a PCI bus need not be included in the computing device 1300.

The memory 1304 may include any of a variety of computer-readable media. The computer-readable media may be any available media that may be accessed by the computing device 1300. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1304 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1300. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1306 may be configured to execute at least some of the computer-readable instructions to control one or more components of the computing device 1300 to perform one or more of the methods and/or processes described herein. The CPU(s) 1306 may each include one or more cores (e.g., one, two, four, eight, twenty-eight, seventy-two, etc.) that are capable of handling a multitude of software threads simultaneously. The CPU(s) 1306 may include any type of processor, and may include different types of processors depending on the type of computing device 1300 implemented (e.g., processors with fewer cores for mobile devices and processors with more cores for servers). For example, depending on the type of computing device 1300, the processor may be an Advanced RISC Machines (ARM) processor implemented using Reduced Instruction Set Computing (RISC) or an x86 processor implemented using Complex Instruction Set Computing (CISC). The computing device 1300 may include one or more CPUs 1306 in addition to one or more microprocessors or supplementary co-processors, such as math co-processors.

In addition to or alternatively from the CPU(s) 1306, the GPU(s) 1308 may be configured to execute at least some of the computer-readable instructions to control one or more components of the computing device 1300 to perform one or more of the methods and/or processes described herein. One or more of the GPU(s) 1308 may be an integrated GPU (e.g., with one or more of the CPU(s) 1306 and/or one or more of the GPU(s) 1308 may be a discrete GPU. In embodiments, one or more of the GPU(s) 1308 may be a coprocessor of one or more of the CPU(s) 1306. The GPU(s) 1308 may be used by the computing device 1300 to render graphics (e.g., 3D graphics) or perform general purpose computations. For example, the GPU(s) 1308 may be used for General-Purpose computing on GPUs (GPGPU). The GPU(s) 1308 may include hundreds or thousands of cores that are capable of handling hundreds or thousands of software threads simultaneously. The GPU(s) 1308 may generate pixel data for output images in response to rendering commands (e.g., rendering commands from the CPU(s) 1306 received via a host interface). The GPU(s) 1308 may include graphics memory, such as display memory, for storing pixel data or any other suitable data, such as GPGPU data. The display memory may be included as part of the memory 1304. The GPU(s) 1308 may include two or more GPUs operating in parallel (e.g., via a link). The link may directly connect the GPUs (e.g., using NVLINK) or may connect the GPUs through a switch (e.g., using NVSwitch). When combined together, each GPU 1308 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1306 and/or the GPU(s) 1308, the logic unit(s) 1320 may be configured to execute at least some of the computer-readable instructions to control one or more components of the computing device 1300 to perform one or more of the methods and/or processes described herein. In embodiments, the CPU(s) 1306, the GPU(s) 1308, and/or the logic unit(s) 1320 may discretely or jointly perform any combination of the methods, processes and/or portions thereof. One or more of the logic units 1320 may be part of and/or integrated in one or more of the CPU(s) 1306 and/or the GPU(s) 1308 and/or one or more of the logic units 1320 may be discrete components or otherwise external to the CPU(s) 1306 and/or the GPU(s) 1308. In embodiments, one or more of the logic units 1320 may be a coprocessor of one or more of the CPU(s) 1306 and/or one or more of the GPU(s) 1308.

Examples of the logic unit(s) 1320 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1310 may include one or more receivers, transmitters, and/or transceivers that enable the computing device 1300 to communicate with other computing devices via an electronic communication network, included wired and/or wireless communications. The communication interface 1310 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1320 and/or communication interface 1310 may include one or more data processing units (DPUs) to transmit data received over a network and/or through interconnect system 1302 directly to (e.g., a memory of) one or more GPU(s) 1308.

The I/O ports 1312 may enable the computing device 1300 to be logically coupled to other devices including the I/O components 1314, the presentation component(s) 1318, and/or other components, some of which may be built in to (e.g., integrated in) the computing device 1300. Illustrative I/O components 1314 include a microphone, mouse, keyboard, joystick, game pad, game controller, satellite dish, scanner, printer, wireless device, etc. The I/O components 1314 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1300. The computing device 1300 may be include depth cameras, such as stereoscopic camera systems, infrared camera systems, RGB camera systems, touchscreen technology, and combinations of these, for gesture detection and recognition. Additionally, the computing device 1300 may include accelerometers or gyroscopes (e.g., as part of an inertia measurement unit (IMU)) that enable detection of motion. In some examples, the output of the accelerometers or gyroscopes may be used by the computing device 1300 to render immersive augmented reality or virtual reality.

The power supply 1316 may include a hard-wired power supply, a battery power supply, or a combination thereof. The power supply 1316 may provide power to the computing device 1300 to enable the components of the computing device 1300 to operate.

The presentation component(s) 1318 may include a display (e.g., a monitor, a touch screen, a television screen, a heads-up-display (HUD), other display types, or a combination thereof), speakers, and/or other presentation components. The presentation component(s) 1318 may receive data from other components (e.g., the GPU(s) 1308, the CPU(s) 1306, DPUs, etc.), and output the data (e.g., as an image, video, sound, etc.).

### Example Data Center

FIG. 14 illustrates an example data center 1400 that may be used in at least one embodiments of the present disclosure. The data center 1400 may include a data center infrastructure layer 1410, a framework layer 1420, a software layer 1430, and/or an application layer 1440.

As shown in FIG. 14, the data center infrastructure layer 1410 may include a resource orchestrator 1412, grouped computing resources 1414, and node computing resources (“node C.R.s”) 1416(1)-1416(N), where “N” represents any whole, positive integer. In at least one embodiment, node C.R.s 1416(1)-1416(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1416(1)-1416(N) may correspond to a server having one or more of the above-mentioned computing resources. In addition, in some embodiments, the node C.R.s 1416(1)-14161 (N) may include one or more virtual components, such as vGPUs, vCPUs, and/or the like, and/or one or more of the node C.R.s 1416(1)-1416(N) may correspond to a virtual machine (VM).

In at least one embodiment, grouped computing resources 1414 may include separate groupings of node C.R.s 1416 housed within one or more racks (not shown), or many racks housed in data centers at various geographical locations (also not shown). Separate groupings of node C.R.s 1416 within grouped computing resources 1414 may include grouped compute, network, memory or storage resources that may be configured or allocated to support one or more workloads. In at least one embodiment, several node C.R.s 1416 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1412 may configure or otherwise control one or more node C.R.s 1416(1)-1416(N) and/or grouped computing resources 1414. In at least one embodiment, resource orchestrator 1412 may include a software design infrastructure (SDI) management entity for the data center 1400. The resource orchestrator 1412 may include hardware, software, or some combination thereof.

In at least one embodiment, as shown in FIG. 14, framework layer 1420 may include a job scheduler 1433, a configuration manager 1434, a resource manager 1436, and/or a distributed file system 1438. The framework layer 1420 may include a framework to support software 1432 of software layer 1430 and/or one or more application(s) 1442 of application layer 1440. The software 1432 or application(s) 1442 may respectively include web-based service software or applications, such as those provided by Amazon Web Services, Google Cloud and Microsoft Azure. The framework layer 1420 may be, but is not limited to, a type of free and open-source software web application framework such as Apache Spark™ (hereinafter “Spark”) that may utilize distributed file system 1438 for large-scale data processing (e.g., “big data”). In at least one embodiment, job scheduler 1433 may include a Spark driver to facilitate scheduling of workloads supported by various layers of data center 1400. The configuration manager 1434 may be capable of configuring different layers such as software layer 1430 and framework layer 1420 including Spark and distributed file system 1438 for supporting large-scale data processing. The resource manager 1436 may be capable of managing clustered or grouped computing resources mapped to or allocated for support of distributed file system 1438 and job scheduler 1433. In at least one embodiment, clustered or grouped computing resources may include grouped computing resource 1414 at data center infrastructure layer 1410. The resource manager 1436 may coordinate with resource orchestrator 1412 to manage these mapped or allocated computing resources.

In at least one embodiment, software 1432 included in software layer 1430 may include software used by at least portions of node C.R.s 1416(1)-1416(N), grouped computing resources 1414, and/or distributed file system 1438 of framework layer 1420. One or more types of software may include, but are not limited to, Internet web page search software, e-mail virus scan software, database software, and streaming video content software.

In at least one embodiment, application(s) 1442 included in application layer 1440 may include one or more types of applications used by at least portions of node C.R.s 1416(1)-1416(N), grouped computing resources 1414, and/or distributed file system 1438 of framework layer 1420. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1434, resource manager 1436, and resource orchestrator 1412 may implement any number and type of self-modifying actions based on any amount and type of data acquired in any technically feasible fashion. Self-modifying actions may relieve a data center operator of data center 1400 from making possibly bad configuration decisions and possibly avoiding underutilized and/or poor performing portions of a data center.

The data center 1400 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1400. In at least one embodiment, trained or deployed machine learning models corresponding to one or more neural networks may be used to infer or predict information using resources described above with respect to the data center 1400 by using weight parameters calculated through one or more training techniques, such as but not limited to those described herein.

In at least one embodiment, the data center 1400 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1300 of FIG. 13—e.g., each device may include similar components, features, and/or functionality of the computing device(s) 1300. In addition, where backend devices (e.g., servers, NAS, etc.) are implemented, the backend devices may be included as part of a data center 1400, an example of which is described in more detail herein with respect to FIG. 14.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1300 described herein with respect to FIG. 13. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Paragraphs

A: A method comprising: generating, using one or more machine learning models and based at least on sensor data generated using a machine navigating within an environment, first data representing one or more values indicating whether one or more locations within the environment are associated with a boundary of an object; determining, based at least on one or more values, that a location of the one or more locations is associated with the boundary of the object; and causing, based at least on the location associated with the boundary of the object, the machine to perform one or more operations

B: The method of paragraph A, wherein the determining that the location is associated with of the boundary of the object comprises: processing the first data using the one or more machine learning models; and generating, using the one or more machine learning models and based at least on the processing, an output indicating that the location is associated with the boundary of the object.

C: The method of paragraph A or paragraph B, wherein the determining that the location is associated with the boundary of the object comprises: determining that the location is associated with a highest value from the one or more values; and determining, based at least on the location being associated with the highest value, that the location is associated with the boundary of the object.

D: The method of any one of paragraphs A-C, wherein the first data represents a grid map that is partitioned into one or more portions associated with the one or more locations, and wherein the one or more values are associated with the one or more portions.

E: The method of any one of paragraphs A-D, wherein: the one or more values associated with the one or more locations include at least: one or more first values associated with one or more first distances from the machine, the one or more first distances corresponding to one or more first locations of the one or more locations; a second value associated with a second distance from the machine, the second distance corresponding to the location of the one or more locations; and one or more third values associated with one or more third distances from the machine, the one or more third distances corresponding to one or more third locations of the one or more locations; and the second value is greater than the one or more first values and the one or more third values.

F: The method of any one of paragraphs A-E, further comprising: generating an obstacle map representing the environment, the obstacle map indicating at least the location associated with the boundary of the object, wherein the causing the machine to perform the one or more operations is based at least on the obstacle map.

G: The method of any one of paragraphs A-F, wherein the one or more values are associated with a first direction with respect to the machine, and wherein the method further comprises: generating, using the one or more machine learning models and based at least on the sensor data, second data representing one or more second values indicating whether one or more second locations within the environment are associated with a second boundary of a second object, the one or more second values being associated with a second direction with respect to the machine; and determining, based at least on the one or more second values, that a second location of the one or more second locations is associated with the second boundary of the second object, wherein the causing the machine to perform the one or more operations is further based at least on the second location associated with the second boundary.

H: The method of any one of paragraphs A-G, wherein the generating the first data representing the one or more values associated with the one or more locations comprises: generating, using the one or more neural networks and based at least on a first portion of the sensor data corresponding to a first sensor modality, second data representing one or more first values associated with the one or more locations; generating, using the one or more neural networks and based at least on a second portion of the sensor data corresponding to a second sensor modality, third data representing one or more second values associated with the one or more locations; and generating, based at least on the one or more first values and the one or more second values, the first data representing the one or more values associated with the one or more locations.

I: The method of any one of paragraphs A-H, further comprising generating, using the one or more machine learning models and based at least on the sensor data, at least one of: a height map indicating one or more heights associated with the one or more locations; or one or more uncertainty values associated with the one or more locations.

J: The method of any one of paragraphs A-I, wherein the sensor data comprises one or more of: image data generated using the machine; LiDAR data generated using the machine; RADAR data generated using the machine; or ultrasonic data generated using the machine.

K: The method of any one of paragraphs A-J, wherein the one or more machine learning models are trained using at least: input data that includes at least second sensor data generated using one or more second machines navigating in one or more second environments; and ground truth data representing at least one or more second values indicating whether one or more second locations within the one or more second environments are associated with one or more second boundaries of one or more second objects.

L: A system comprising: one or more processing units to: obtain sensor data generated using a machine navigating within an environment; generate, using one or more machine learning models and based at least on the sensor data, output data representing a location associated with a boundary of an object located within the environment; and cause, based at least on the output data, the machine to perform one or more operations.

M: The system of paragraph L, wherein the generation of the output data comprises: determining, using the one or more machine learning models and based at least on the sensor data, one or more values indicating whether one or more locations within the environment are associated with the boundary of the object; determining, using the one or more machine learning models and based at least on the one or more values, that the location of the one or more locations is associated with the boundary of the object; and based at least on the determining that the location is associated with the boundary, generating, using the one or more machine learning models, the output data representing the location associated with the boundary of the object.

N: The system of paragraph M, wherein the determining that the location from the one or more locations is associated with the boundary of the object comprises: determining that the location is associated with a maximum value of the one or more values; and determining, based at least on the location being associated with the maximum value, that the location is associated with the boundary of the object.

O: The system of any one of paragraphs L-N, wherein the output data represents a grid map of the environment that is partitioned into one or more portions associated with one or more locations, and wherein the grid map indicates that the location of the one or more locations is associated with the boundary of the object.

P: The system of any one of paragraphs L-O, wherein: the output data represents: one or more first values associated with one or more second locations within the environment; a second value associated with the location within the environment; and one or more third values associated with one or more third locations within the environment; and the second value is greater than the one or more first values and the one or more third values.

Q: The system of any one of paragraphs L-P wherein the output data represents an obstacle map associated with the environment, the obstacle map indicating the location associated with the boundary of the object.

R: The system of any one of paragraphs L-Q, wherein the system is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system implemented using an edge device; a system implemented using a robot; a system for performing conversational AI operations; a system implementing one or more large language models (LLMs); a system for performing generative AI operations; a system for generating synthetic data; a system incorporating one or more virtual machines (VMs); a system implemented at least partially in a data center; or a system implemented at least partially using cloud computing resources.

S: A processor comprising: one or more processing units to cause a machine to perform one or more operations based at least on output data representing one or more locations associated with one or more boundaries of one or more objects located within an environment, wherein one or more machine learning models generate the output data representing the one or more locations associated with the one or more boundaries based at least on processing sensor data generated using the machine.

T: The processor of paragraph S, wherein the processor is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system implemented using an edge device; a system implemented using a robot; a system for performing conversational AI operations; a system implementing one or more large language models (LLMs); a system for performing generative AI operations; a system for generating synthetic data; a system incorporating one or more virtual machines (VMs); a system implemented at least partially in a data center; or a system implemented at least partially using cloud computing resources.

What is claimed is:

1. A method comprising:
generating, using one or more machine learning models and based at least on sensor data generated using a machine navigating within an environment, first data representing one or more values indicating whether one or more locations within the environment are associated with a boundary of an object;
determining, based at least on one or more values, that a location of the one or more locations is associated with the boundary of the object; and
causing, based at least on the location associated with the boundary of the object, the machine to perform one or more operations.

2. The method of claim 1, wherein the determining that the location is associated with of the boundary of the object comprises:
processing the first data using the one or more machine learning models; and
generating, using the one or more machine learning models and based at least on the processing, an output indicating that the location is associated with the boundary of the object.

3. The method of claim 1, wherein the determining that the location is associated with the boundary of the object comprises:
determining that the location is associated with a highest value from the one or more values; and
determining, based at least on the location being associated with the highest value, that the location is associated with the boundary of the object.

4. The method of claim 1, wherein the first data represents a grid map that is partitioned into one or more portions associated with the one or more locations, and wherein the one or more values are associated with the one or more portions.

5. The method of claim 1, wherein:
the one or more values associated with the one or more locations include at least:
one or more first values associated with one or more first distances from the machine, the one or more first distances corresponding to one or more first locations of the one or more locations;
a second value associated with a second distance from the machine, the second distance corresponding to the location of the one or more locations; and
one or more third values associated with one or more third distances from the machine, the one or more third distances corresponding to one or more third locations of the one or more locations; and
the second value is greater than the one or more first values and the one or more third values.

6. The method of claim 1, further comprising:
generating an obstacle map representing the environment, the obstacle map indicating at least the location associated with the boundary of the object,
wherein the causing the machine to perform the one or more operations is based at least on the obstacle map.

7. The method of claim 1, wherein the one or more values are associated with a first direction with respect to the machine, and wherein the method further comprises:
generating, using the one or more machine learning models and based at least on the sensor data, second data representing one or more second values indicating whether one or more second locations within the environment are associated with a second boundary of a second object, the one or more second values being associated with a second direction with respect to the machine; and
determining, based at least on the one or more second values, that a second location of the one or more second locations is associated with the second boundary of the second object,
wherein the causing the machine to perform the one or more operations is further based at least on the second location associated with the second boundary.

8. The method of claim 1, wherein the generating the first data representing the one or more values associated with the one or more locations comprises:
generating, using the one or more neural networks and based at least on a first portion of the sensor data corresponding to a first sensor modality, second data representing one or more first values associated with the one or more locations;
generating, using the one or more neural networks and based at least on a second portion of the sensor data corresponding to a second sensor modality, third data representing one or more second values associated with the one or more locations; and
generating, based at least on the one or more first values and the one or more second values, the first data representing the one or more values associated with the one or more locations.

9. The method of claim 1, further comprising generating, using the one or more machine learning models and based at least on the sensor data, at least one of:
a height map indicating one or more heights associated with the one or more locations; or
one or more uncertainty values associated with the one or more locations.

10. The method of claim 1, wherein the sensor data comprises one or more of:
image data generated using the machine;
LiDAR data generated using the machine;
RADAR data generated using the machine; or
ultrasonic data generated using the machine.

11. The method of claim 1, wherein the one or more machine learning models are trained using at least:
input data that includes at least second sensor data generated using one or more second machines navigating in one or more second environments; and
ground truth data representing at least one or more second values indicating whether one or more second locations within the one or more second environments are associated with one or more second boundaries of one or more second objects.

12. A system comprising:
one or more processing units to:
obtain sensor data generated using a machine navigating within an environment;
generate, using one or more machine learning models and based at least on the sensor data, output data representing a location associated with a boundary of an object located within the environment; and
cause, based at least on the output data, the machine to perform one or more operations.

13. The system of claim 12, wherein the generation of the output data comprises:
determining, using the one or more machine learning models and based at least on the sensor data, one or more values indicating whether one or more locations within the environment are associated with the boundary of the object;
determining, using the one or more machine learning models and based at least on the one or more values, that the location of the one or more locations is associated with the boundary of the object; and
based at least on the determining that the location is associated with the boundary, generating, using the one or more machine learning models, the output data representing the location associated with the boundary of the object.

14. The system of claim 13, wherein the determining that the location from the one or more locations is associated with the boundary of the object comprises:
determining that the location is associated with a maximum value of the one or more values; and
determining, based at least on the location being associated with the maximum value, that the location is associated with the boundary of the object.

15. The system of claim 12, wherein the output data represents a grid map of the environment that is partitioned into one or more portions associated with one or more locations, and wherein the grid map indicates that the location of the one or more locations is associated with the boundary of the object.

16. The system of claim 12, wherein:
the output data represents:
one or more first values associated with one or more second locations within the environment;
a second value associated with the location within the environment; and
one or more third values associated with one or more third locations within the environment; and
the second value is greater than the one or more first values and the one or more third values.

17. The system of claim 12, wherein the output data represents an obstacle map associated with the environment, the obstacle map indicating the location associated with the boundary of the object.

18. The system of claim 12, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system implementing one or more large language models (LLMs);
a system for performing generative AI operations;
a system for generating synthetic data;
a system incorporating one or more virtual machines (VMs);
a system implemented at least partially in a data center; or
a system implemented at least partially using cloud computing resources.

19. A processor comprising:
one or more processing units to cause a machine to perform one or more operations based at least on output data representing one or more locations associated with one or more boundaries of one or more objects located within an environment, wherein one or more machine learning models generate the output data representing the one or more locations associated with the one or more boundaries based at least on processing sensor data generated using the machine.

20. The processor of claim 19, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system implementing one or more large language models (LLMs);
a system for performing generative AI operations;
a system for generating synthetic data;
a system incorporating one or more virtual machines (VMs);
a system implemented at least partially in a data center; or
a system implemented at least partially using cloud computing resources.
